(19) United States
(12) Patent Application Publication
(10) Pub. No.: US 2024/0134116 A1
(43) Pub. Date: Apr. 25, 2024

(54) OPTICAL DEVICE, OPTICAL TRANSMITTER, AND OPTICAL RECEIVER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/235,930

(22) Filed: Aug. 20, 2023

(30) Foreign Application Priority Data
Oct. 23, 2022 (JP) 2022-169703

(51) Int. Cl. G02B 6/122

(52) U.S. Cl. CPC G02B 6/1228

(57) ABSTRACT

An optical device includes a first layer, a second layer, two first waveguides arranged in a side by side manner in the first layer; two second waveguides arranged in a side by side manner in the second layer, and a third waveguide arranged between the first waveguides and between the second waveguides. The first waveguide includes a first tapered waveguide and a second tapered waveguide. The third waveguide includes a third tapered waveguide that is disposed side by side with the second tapered waveguides. The first tapered waveguide has a width that is gradually narrower as the first tapered waveguide is away from a joining point with the second tapered waveguide. The second tapered waveguide has a width that is gradually narrower as the second tapered waveguide is away from a joining point with the first tapered waveguide. The third tapered waveguide has a width that is gradually wider.

### CROSS-REFERENCE TO RELATED APPLICATION

This application is based upon and claims the benefit of priority of the prior Japanese Patent Application No. 2022-169703, filed on Oct. 24, 2022, the entire contents of which are incorporated herein by reference.

### FIELD

The embodiments discussed herein are related to an optical device, an optical transmitter, and an optical receiver.

### BACKGROUND

In recent years, there are increased demands for optical fiber communication in accordance with an increase in communication capacity, so that small-sized optical devices that convert electrical signals to optical signals are used. Accordingly, in recent years, development of an ultra-compact substrate type optical waveguide element (hereinafter, simply referred to as an optical device) represented by silicon photonics is actively studied. In the optical device, an edge coupler in which two or more waveguides made of different materials can be integrally mounted on a same chip is used.

The optical components constituting the optical device each have a different characteristic depending on, for example, a material refractive index, so that it is possible to improve the characteristic of the optical device by using a waveguide made of a suitable material for each of the optical components. Therefore, the optical device constituted by using waveguides that are made of different materials has a structure in which light is adiabatically and optically transitioned between different waveguides.

FIG. 22 is a diagram illustrating one example of an optical device 100 according to conventional example 1. The optical device 100 illustrated in FIG. 22 is a substrate type optical waveguide element that is optically coupled to a core of an optical fiber. The optical device 100 includes a clad 111 that is made of SiO₂ or the like, and a first waveguide 102 that is covered by the clad 111 and that is made of, for example, Si₃N₄ (hereinafter, simply referred to as Silicon Nitride (SiN)), or the like. The optical device 100 includes a second waveguide 104 that is covered by the clad 111 and that is made of, for example, Si or the like, and an adiabatic conversion unit 105 in which light is adiabatically and optically transitioned between the first waveguide 102 and the second waveguide 104.

The first waveguide 102 includes a first tapered waveguide 102A, and a second tapered waveguide 102B that is connected to the first tapered waveguide 102A. The first tapered waveguide 102A has a structure in which the waveguide width is gradually narrower to a chip end surface D11 that is a start point of the first tapered waveguide 102A as the first tapered waveguide 102A is away from the joining point with the second tapered waveguide 102B. The second tapered waveguide 102B has a structure in which the waveguide width is gradually narrower as the second tapered waveguide 102B is away from the joining point with the first tapered waveguide 102A.

The second waveguide 104 includes a third tapered waveguide 104A that is arranged below the second tapered waveguide 102B, and a straight line waveguide 104B that is connected to the third tapered waveguide 104A. The third tapered waveguide 104A has a structure in which the waveguide width is gradually wider, from the start point of the second tapered waveguide 102B at a position below the second tapered waveguide 102B as the third tapered waveguide 104A is closer to the joining point with the straight line waveguide 104B. The straight line waveguide 104B is a straight line waveguide in which the waveguide width from the joining point with the third tapered waveguide 104A to the chip end surface D12 is constant.

FIG. 23A is a diagram illustrating one example of a schematic cross-sectional portion taken along line A-A illustrated in FIG. 22. The optical device 100 illustrated in FIG. 23A includes a Si substrate 112, and the clad 111 that is laminated on the Si substrate 112. The schematic cross-sectional portion taken along the line A-A illustrated in FIG. 23A is a cross-sectional part of the optical device 100 in which the first tapered waveguide 102A is arranged. Furthermore, the optical device 100 includes a first assembly layer 121A that is formed on the Si substrate 112 on the side closer to the Si substrate 112, and a second assembly layer 121B that is formed on the Si substrate 112 on the side away from the Si substrate 112. In the second assembly layer 121B, the first tapered waveguide 102A included in the first waveguide 102 is arranged.

FIG. 23B is a diagram illustrating one example of a schematic cross-sectional portion taken along line B-B illustrated in FIG. 22. The optical device 100 illustrated in FIG. 23B includes the Si substrate 112, the clad 111, the first assembly layer 121A, and the second assembly layer 121B. The schematic cross-sectional portion taken along the line B-B illustrated in FIG. 23B is a cross sectional part of the optical device 100 in which the start point of the adiabatic conversion unit 105 is arranged. In the first assembly layer 121A, the third tapered waveguide 104A included in the second waveguide 104 is arranged. In the second assembly layer 121B, the joining point between the first tapered waveguide 102A and the second tapered waveguide 102B included in the first waveguide 102 is arranged.

FIG. 23C is a diagram illustrating one example of a schematic cross-sectional portion taken along line C-C illustrated in FIG. 22. The optical device 100 illustrated in FIG. 23C includes the Si substrate 112, the clad 111, the first assembly layer 121A, and the second assembly layer 121B. The schematic cross-sectional portion taken along the line C-C illustrated in FIG. 23C is a cross-sectional part of the optical device 100 in which the straight line waveguide 104B is arranged. In the first assembly layer 121A, the straight line waveguide 104B included in the second waveguide 104 is arranged.

In the adiabatic conversion unit 105 included in the optical device 100 illustrated in FIG. 22, the waveguide width of the second waveguide 104 is changed in a tapered manner. The first waveguide 102 has the refractive index that is lower than that of the second waveguide 104, so that it is possible to increase a mode field of light, and it is thus possible to reduce a coupling loss with the optical fiber.

However, in the optical device 100 illustrated in FIG. 22, the mode field of the second waveguide 104 is smaller than the mode field of the optical fiber, so that a coupling loss occurs caused by a mismatch of the mode field. Accordingly, an optical device 100A according to conventional example 2 that reduces the coupling loss with the optical fiber is known.

FIG. 24 is a diagram illustrating one example of the optical device 100A according to conventional example 2. The optical device 100A illustrated in FIG. 24 is a substrate type optical waveguide element that is optically coupled to the core of the optical fiber. The optical device 100A includes a first waveguide 152, a second waveguide 154, and a clad 161 that covers the first waveguide 152 and the second waveguide 154. Furthermore, the optical device 100A includes an adiabatic conversion unit 155A that allows light to be optically transitioned between the first waveguide 152 and the second waveguide 154, and two third waveguides 153. The first waveguide 152 is made of, for example, Si₃N₄ (hereinafter, simply referred to as SiN), and the material refractive index of SiN is 1.99 in the case where the optical wavelength is 1.55 μm. The second waveguide 154 is made of, for example, Si, and the material refractive index of Si is 3.48 in the case where the optical wavelength is 1.55 μm. The clad 161 is made of, for example, SiO₂, and the material refractive index of SiO₂ is 1.44 in the case where the optical wavelength is 1.55 μm.

The first waveguide 152 includes three first straight line waveguides 152A1, 152A2, and 152A3, and a second tapered waveguide 152B that is connected to the three first straight line waveguides 152A1, 152A2, and 152A3. Each of the first straight line waveguides 152A1, 152A2, and 152A3 is a waveguide in which the waveguide width from the chip end surface D11 corresponding to the start point X11 to the joining point X12 is constant. The second tapered waveguide 152B is a waveguide that has a tapered structure in which the waveguide width is gradually narrower from the joining point X12 of each of the first straight line waveguides 152A1, 152A2, and 152A3 toward the end point X13. The waveguide width of the joining point X12 that is the start point of the second tapered waveguide 102B is wider than the waveguide width of the end point X13 of the second tapered waveguide 152B. It is assumed that the thickness of each of the first straight line waveguides 152A1, 152A2, and 152A3 is the same as that of the core of the second tapered waveguide 152B. It is assumed that the start point X11 of the first waveguide 152 starts from the chip end surface D11 of the optical device 100A that is optically coupled to the core of the optical fiber.

The third waveguide 153 includes two fourth tapered waveguides 153A1 and 153A2. Each of the fourth tapered waveguides 153A1 and 153A2 has a structure in which the waveguide width is gradually narrower starting from, as a start point, the chip end surface D11 toward the second tapered waveguide 152B. The fourth tapered waveguide 153A1 is arranged on the first straight line waveguide 152A3, whereas the fourth tapered waveguide 153A2 is arranged below the first straight line waveguide 152A3.

The second waveguide 154 includes a third tapered waveguide 154A, and a straight line waveguide 154B that is connected to the third tapered waveguide 154A. The third tapered waveguide 154A is a waveguide that has a tapered structure in which the waveguide width is gradually wider from the start point Y11 toward the joining point Y12 with the straight line waveguide 154B. The straight line waveguide 154B is a waveguide in which the waveguide width from the third tapered waveguide 154A toward the chip end surface D12 is constant. The thickness of the core of the straight line waveguide 154B is set to be the same as that of the third tapered waveguide 154A.

The adiabatic conversion unit 155A is constituted such that the third tapered waveguide 154A is arranged below the second tapered waveguide 152B in an overlapped manner with a space, in the vertical direction, between the second tapered waveguide 152B and the third tapered waveguide 154A. In addition, a space between the second tapered waveguide 152B and the third tapered waveguide 154A is set to be constant.

FIG. 25A is a diagram illustrating one example of a schematic cross-sectional portion taken along line A-A illustrated in FIG. 24. The schematic cross-sectional portion taken along the line A-A illustrated in FIG. 25A is a cross-sectional part of the optical device 100A in which the three first straight line waveguides 152A1, 152A2, and 152A3 included in the first waveguide 152 are arranged. The optical device 100A includes a Si substrate 162, the clad 161 that is laminated on the Si substrate 162, a first assembly layer 181A, a second assembly layer 181B, and a third assembly layer 181C.

The first assembly layer 181A is an assembly layer that is arranged between the second assembly layer 181B and the third assembly layer 181C. The third assembly layer 181C is an assembly layer that is arranged between the Si substrate 162 and the first assembly layer 181A.

In the first assembly layer 181A, each of the three first straight line waveguides 152A1, 152A2, and 152A3 included in the first waveguide 152 are arranged. In the second assembly layer 181B, the fourth tapered waveguide 153A1 included in the third waveguide 153 is arranged. In the third assembly layer 181C, the fourth tapered waveguide 153A2 included in the third waveguide 153 is arranged.

FIG. 25B is a diagram illustrating one example of a schematic cross-sectional portion taken along line B-B illustrated in FIG. 24. The schematic cross-sectional portion taken along the line B-B illustrated in FIG. 25B is a cross-sectional part of the optical device 100A in which the adiabatic conversion unit 155A is arranged. The optical device 100A includes the Si substrate 162, the clad 161, the first assembly layer 181A, the second assembly layer 181B, and the third assembly layer 181C.

In the first assembly layer 181A, the second tapered waveguide 152B included in the first waveguide 152 is arranged. In the third assembly layer 181C, the third tapered waveguide 154A included in the second waveguide 154 is arranged.

FIG. 25C is a diagram illustrating one example of a schematic cross-sectional portion taken along line C-C illustrated in FIG. 24. The schematic cross-sectional portion taken along the C-C illustrated in FIG. 25C is a cross-sectional part of the optical device 100A in which the straight line waveguide 154B included in the second waveguide 154 is arranged. The optical device 100A includes the Si substrate 162, the clad 161, the first assembly layer 181A, the second assembly layer 181B, and the third assembly layer 181C. In the third assembly layer 181C, straight line waveguide 154B included in the second waveguide 154 is arranged.

It is assumed that the structure is constituted such that, at the start point of the adiabatic conversion unit 155A, the waveguide width of the second tapered waveguide 152B is wide, whereas the waveguide width of the third tapered waveguide 154A is narrow, and, at the end point, the waveguide width of the second tapered waveguide 152B is narrow, whereas the waveguide width of the third tapered waveguide 154A is wide. In other words, the structure is constituted such that the waveguide width of the second tapered waveguide 152B is gradually narrower from the start point to the end point, and the waveguide width of the third tapered waveguide 154A is gradually wider from the start point toward the end point. In general, confinement of light with respect to the core is stronger as the waveguide width of the waveguide is wider, so that the effective refractive index is increased as a result of the effect of the material refractive index of the core.

In the optical device 100A, the three first straight line waveguides 152A1, 152A2, and 152A3 included in the first waveguide 152 are arranged in the first assembly layer 181A, and the fourth tapered waveguide 153A1 included in the third waveguide 153 is arranged in the second assembly layer 181B. Furthermore, in the optical device 100A, the fourth tapered waveguide 153A2 included in the third waveguide 153 is arranged in the third assembly layer 181C. As a result, as compared to the optical device 100A that is conventionally used, it is possible to suppress the coupling loss with the optical fiber by bringing the mode field of the first waveguide 152 closer to the mode field of the optical fiber.

The fourth tapered waveguide 153A1 and the fourth tapered waveguide 153A2 are made narrow in a tapered manner, so that light is allowed to be transitioned to the first straight line waveguide 152A3 included in the first waveguide 152 in the first assembly layer 181A. Furthermore, the three divided portions included in the respective first assembly layers 181A are combined into one that corresponds to the second tapered waveguide 152B, and then, light is allowed to be adiabatically and optically transitioned to the third tapered waveguide 154A.
Patent Document 1: U.S. Publication No. 2018/0067259
Patent Document 2: U.S. Publication No. 2019/0369333
Patent Document 3: U.S. Publication No. 2017/0371102

In the optical device 100A, the terminal end of the fourth tapered waveguide 153A1, the terminal end of the fourth tapered waveguide 153A2, the terminal ends of the three first straight line waveguides 152A1, 152A2, and 152A3 are connected to the second tapered waveguide 152B included in the adiabatic conversion unit 155A. However, the joining portion with the second tapered waveguide 152B included in the connected adiabatic conversion unit 155A corresponds to a discontinuous portion, so that the mode field of light is sharply changed. As a result, a radiation loss and a reflection loss in light occurs in a section to the adiabatic conversion unit 105.

### SUMMARY

According to an aspect of an embodiment, an optical device includes a first assembly layer that is formed on a substrate on a side closer to the substrate, and a second assembly layer that is formed on the substrate on a side away from the substrate. The optical device includes two first waveguides that are arranged in a side by side manner in the first assembly layer, two second waveguides that are arranged in a side by side manner in the second assembly layer, and a single third waveguide that is arranged between the first waveguides and between the second waveguides. Each of the first waveguides includes a first tapered waveguide, and a second tapered waveguide that is connected to the first tapered waveguide. The third waveguide includes a third tapered waveguide that is disposed side by side with the second tapered waveguides, and a fourth waveguide that is connected to the third tapered waveguide on a side away from each of the first tapered waveguides. Each of the first tapered waveguides has a structure in which a waveguide width is gradually narrower to a start point of the first tapered waveguide as the first tapered waveguide is away from a joining point with the associated second tapered waveguide. Each of the second tapered waveguides has a structure in which a waveguide width is gradually narrower as the second tapered waveguide is away from a joining point with the associated first tapered waveguide. The third tapered waveguide has a structure in which a waveguide width is gradually wider as the third tapered waveguide is closer to a joining point with the fourth waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of an optical device according to a first embodiment;

FIG. 2A is a diagram illustrating one example of a schematic cross-sectional portion taken along line A-A illustrated in FIG. 1;

FIG. 2B is a diagram illustrating one example of a schematic cross-sectional portion taken along line B-B illustrated in FIG. 1;

FIG. 2C is a diagram illustrating one example of a schematic cross-sectional portion taken along line C-C illustrated in FIG. 1;

FIG. 2D is a diagram illustrating one example of a schematic cross-sectional portion taken along line D-D illustrated in FIG. 1;

FIG. 3 is a diagram illustrating one example of an optical device according to a second embodiment;

FIG. 4A is a diagram illustrating one example of a schematic cross-sectional portion taken along line A-A illustrated in FIG. 3;

FIG. 4B is a diagram illustrating one example of a schematic cross-sectional portion taken along line B-B illustrated in FIG. 3;

FIG. 4C is a diagram illustrating one example of a schematic cross-sectional portion taken along line C-C illustrated in FIG. 3;

FIG. 4D is a diagram illustrating one example of a schematic cross-sectional portion taken along line D-D illustrated in FIG. 3;

FIG. 5 is a diagram illustrating one example of an optical device according to a third embodiment;

FIG. 6A is a diagram illustrating one example of a schematic cross-sectional portion taken along line A-A illustrated in FIG. 5;

FIG. 6B is a diagram illustrating one example of a schematic cross-sectional portion taken along line B-B illustrated in FIG. 5;

FIG. 6C is a diagram illustrating one example of a schematic cross-sectional portion taken along line C-C illustrated in FIG. 5;

FIG. 6D is a diagram illustrating one example of a schematic cross-sectional portion taken along line D-D illustrated in FIG. 5;

FIG. 6E is a diagram illustrating one example of a schematic cross-sectional portion taken along line E-E illustrated in FIG. 5;

FIG. 7 is a diagram illustrating one example of an optical device according to a fourth embodiment;

FIG. 8A is a diagram illustrating one example of a schematic cross-sectional portion taken along line A-A illustrated in FIG. 7;

FIG. 8B is a diagram illustrating one example of a schematic cross-sectional portion taken along line B-B illustrated in FIG. 7;

FIG. 8C is a diagram illustrating one example of a schematic cross-sectional portion taken along line C-C illustrated in FIG. 7;

FIG. 8D is a diagram illustrating one example of a schematic cross-sectional portion taken along line D-D illustrated in FIG. 7;

FIG. 8E is a diagram illustrating one example of a schematic cross-sectional portion taken along line E-E illustrated in FIG. 7;

FIG. 9 is a diagram illustrating one example of an optical device according to a fifth embodiment;

FIG. 10A is a diagram illustrating one example of a schematic cross-sectional portion taken along line A-A illustrated in FIG. 9;

FIG. 10B is a diagram illustrating one example of a schematic cross-sectional portion taken along line B-B illustrated in FIG. 9;

FIG. 10C is a diagram illustrating one example of a schematic cross-sectional portion taken along line C-C illustrated in FIG. 9;

FIG. 10D is a diagram illustrating one example of a schematic cross-sectional portion taken along line D-D illustrated in FIG. 9;

FIG. 10E is a diagram illustrating one example of a schematic cross-sectional portion taken along line E-E illustrated in FIG. 9;

FIG. 11 is a diagram illustrating one example of an optical device according to a sixth embodiment;

FIG. 12A is a diagram illustrating one example of a schematic cross-sectional portion taken along line A-A illustrated in FIG. 11;

FIG. 12B is a diagram illustrating one example of a schematic cross-sectional portion taken along line B-B illustrated in FIG. 11;

FIG. 13 is a diagram illustrating one example of an optical device according to a seventh embodiment;

FIG. 14A is a diagram illustrating one example of a schematic cross-sectional portion taken along line A-A illustrated in FIG. 13;

FIG. 14B is a diagram illustrating one example of a schematic cross-sectional portion taken along line B-B illustrated in FIG. 13;

FIG. 14C is a diagram illustrating one example of a schematic cross-sectional portion taken along line C-C illustrated in FIG. 13;

FIG. 15 is a diagram illustrating one example of an optical device according to an eighth embodiment;

FIG. 16 is a diagram illustrating one example of a schematic cross-sectional portion taken along line A-A illustrated in FIG. 15;

FIG. 17 is a diagram illustrating one example of an optical device according to a ninth embodiment;

FIG. 18A is a diagram illustrating one example of a schematic cross-sectional portion taken along line A-A illustrated in FIG. 17;

FIG. 18B is a diagram illustrating one example of a schematic cross-sectional portion taken along line B-B illustrated in FIG. 17;

FIG. 18C is a diagram illustrating one example of a schematic cross-sectional portion taken along line C-C illustrated in FIG. 17;

FIG. 18D is a diagram illustrating one example of a schematic cross-sectional portion taken along line D-D illustrated in FIG. 17;

FIG. 19 is a diagram illustrating one example of an optical communication apparatus in which an optical device is included as a built-in device;

FIG. 20 is a diagram illustrating one example of an optical device according to a comparative example;

FIG. 21A is a diagram illustrating one example of a schematic cross-sectional portion taken along line A-A illustrated in FIG. 20;

FIG. 21B is a diagram illustrating one example of a schematic cross-sectional portion taken along line B-B illustrated in FIG. 20;

FIG. 21C is a diagram illustrating one example of a schematic cross-sectional portion taken along line C-C illustrated in FIG. 20;

FIG. 22 is a diagram illustrating one example of an optical device according to conventional example 1;

FIG. 23A is a diagram illustrating one example of a schematic cross-sectional portion taken along line A-A illustrated in FIG. 22;

FIG. 23B is a diagram illustrating one example of a schematic cross-sectional portion taken along line B-B illustrated in FIG. 22;

FIG. 23C is a diagram illustrating one example of a schematic cross-sectional portion taken along line C-C illustrated in FIG. 22;

FIG. 24 is a diagram illustrating one example of an optical device according to conventional example 2;

FIG. 25A is a diagram illustrating one example of a schematic cross-sectional portion taken along line A-A illustrated in FIG. 24;

FIG. 25B is a diagram illustrating one example of a schematic cross-sectional portion taken along line B-B illustrated in FIG. 24; and

FIG. 25C is a diagram illustrating one example of a schematic cross-sectional portion taken along line C-C illustrated in FIG. 24.

### DESCRIPTION OF EMBODIMENTS

In the following, an optical device that is capable of suppressing a radiation loss and a reflection loss in a section to an adiabatic conversion unit while reducing a coupling loss with a fiber at a chip end surface will be described.

### Comparative Example

FIG. 20 is a diagram illustrating one example of an optical device 80 according to a comparative example. The optical device 80 illustrated in FIG. 20 is a substrate type optical waveguide element that is optically coupled to a core of an optical fiber. The optical device 80 includes a first waveguide 82, a second waveguide 84, and a clad 81 that covers the first waveguide 82 and the second waveguide 84. Furthermore, the optical device 80 includes an adiabatic conversion unit 85 that allows light to be adiabatically and optically transitioned between the first waveguide 82 and the second waveguide 84. The first waveguide 82 is made of, for example, Si₃N₄ (hereinafter, simply referred to as SiN), and the material refractive index of SiN is 1.99 in the case where the optical wavelength is 1.55 μm. The second waveguide 84 is made of, for example, Si, and the material refractive index of Si is 3.48 in the case where the optical wavelength is 1.55 μm. The clad 81 is made of, for example, SiO₂, and the material refractive index of SiO₂ is 1.44 in the case where the optical wavelength is 1.55 μm.

The first waveguide 82 includes two first straight line waveguides 82A that are arranged side by side in respective second assembly layers 85B, and two second straight line waveguides 82B that are arranged side by side in respective first assembly layers 85A. Each of the first straight line waveguides 82A is a waveguide in which the waveguide width from the start point of the chip end surface D21 to the end point is constant. Each of the second straight line waveguides 82B is a waveguide in which the waveguide width from the start point of the chip end surface D21 to the end point is constant. The thickness of the core of each of the first straight line waveguides 82A is set to be the same as that of each of the second straight line waveguides 82B. The second straight line waveguides 82B are arranged above the respective first straight line waveguides 82A.

The second waveguide 84 is arranged in a third assembly layer 85C. The second waveguide 84 includes a first tapered waveguide 84A, and a straight line waveguide 84B that is connected to the first tapered waveguide 84A. The first tapered waveguide 84A is a waveguide having a tapered structure in which the waveguide width is gradually wider from the start point toward the end point. The straight line waveguide 84B is a waveguide in which the waveguide width from the start point toward the end point is constant. The thickness of the core of the straight line waveguide 84B is set to be the same as that of the first tapered waveguide 84A. The end point of the straight line waveguide 84B included in the second waveguide 84 ends, as the end point, at a chip end surface D22 that is located opposite the chip end surface D21 of the optical device 80.

The adiabatic conversion unit 85 is constituted such that the first tapered waveguide 84A is arranged between the first waveguides 82 in a state in which a portion between the first waveguide 82 and the first tapered waveguide 84A is separated.

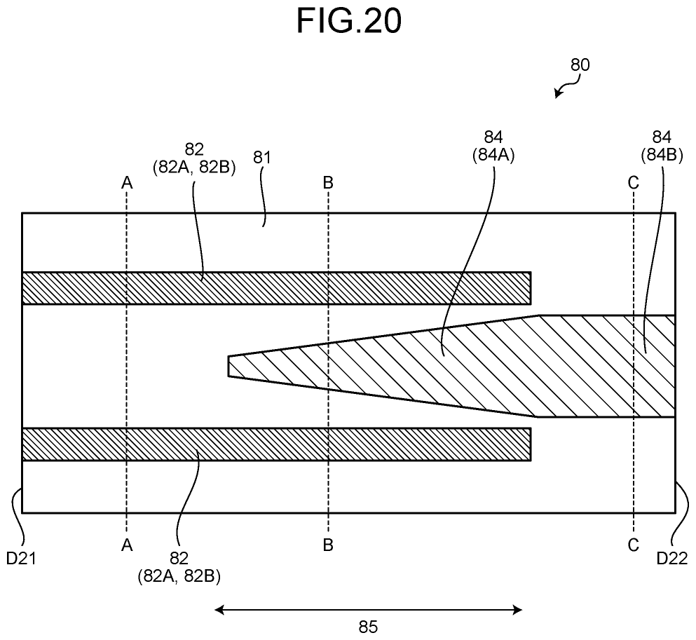

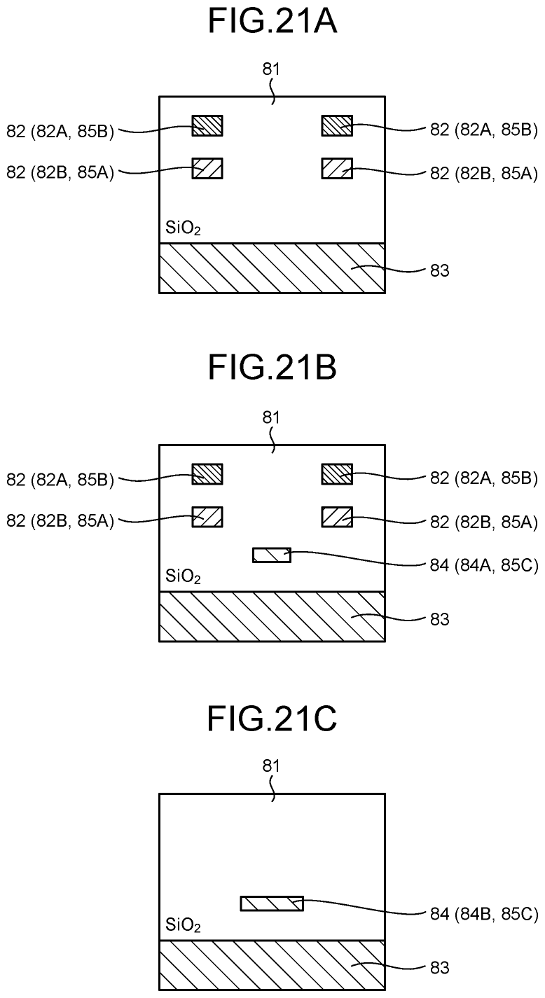

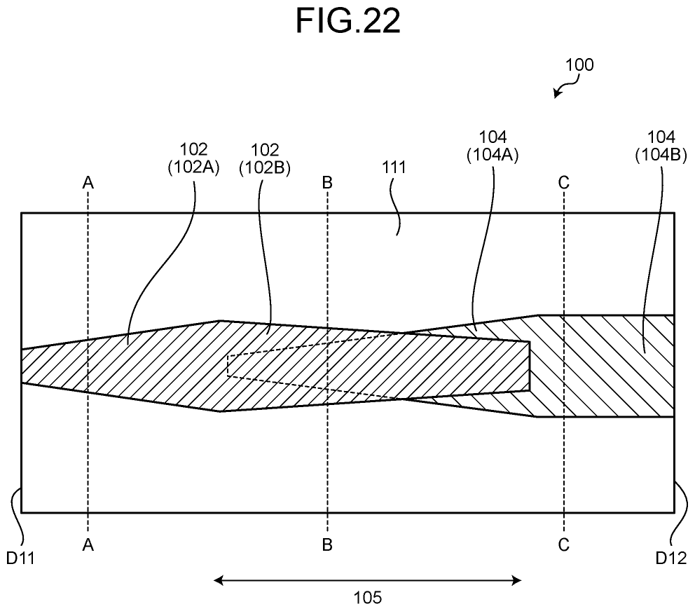

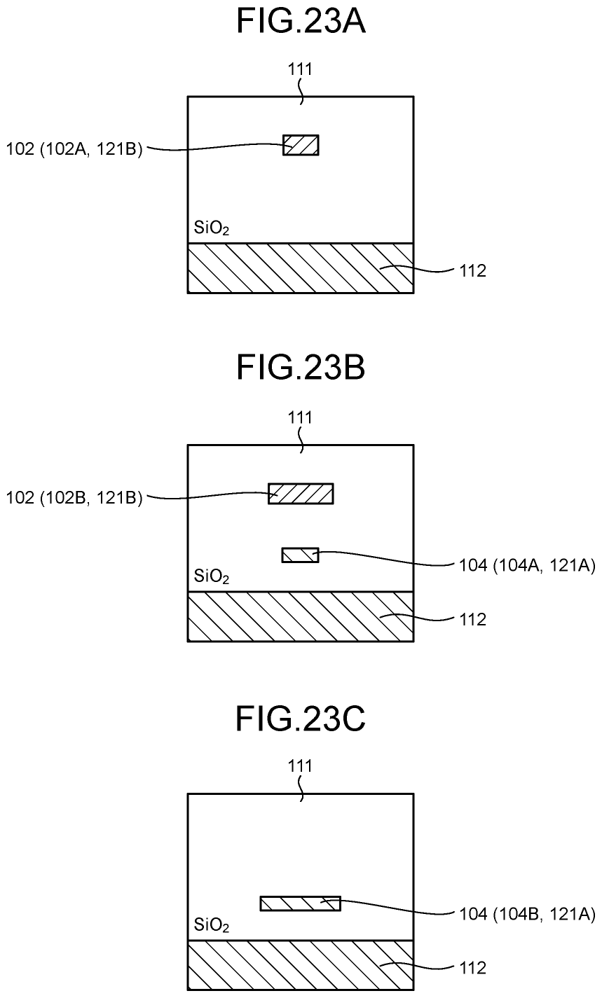

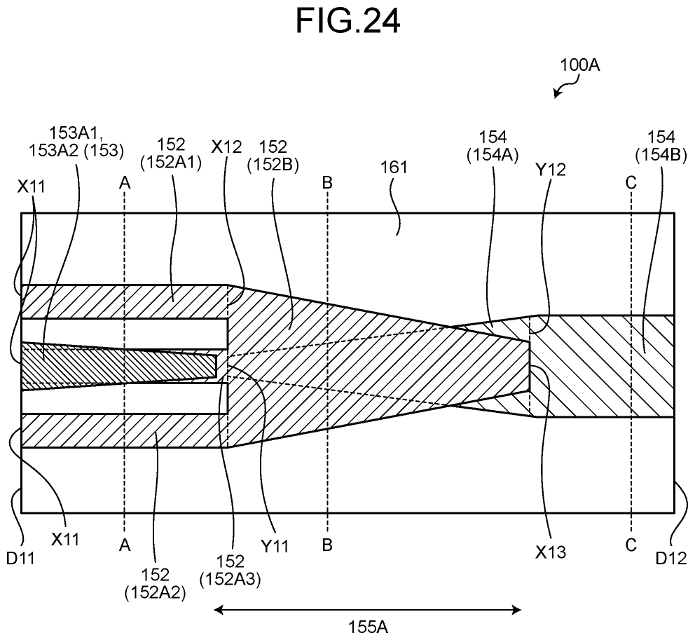

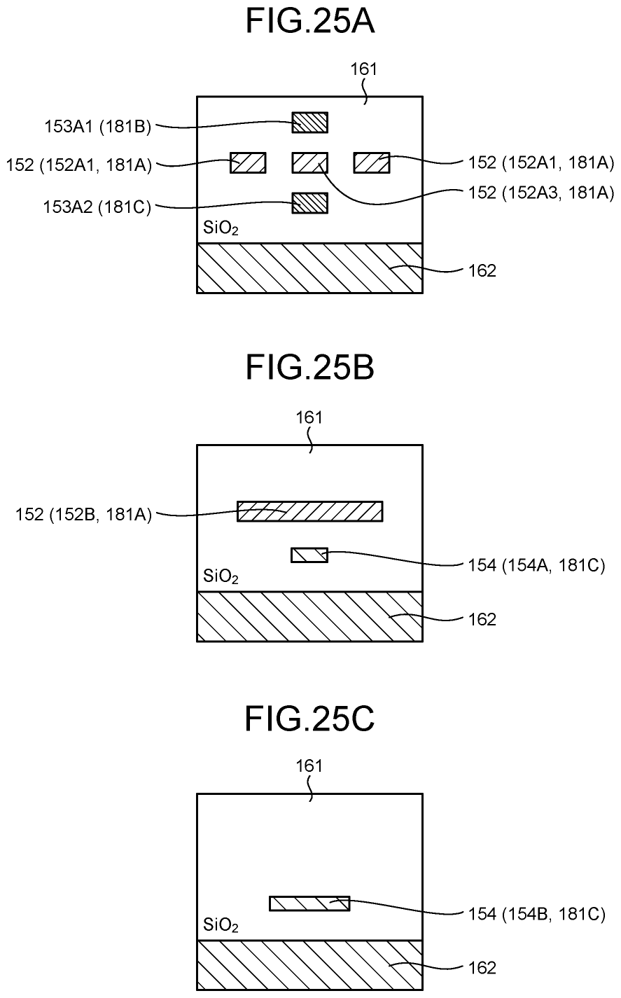

FIG. 21A is a diagram illustrating one example of a schematic cross-sectional portion taken along line A-A illustrated in FIG. 20. The schematic cross-sectional portion taken along the line A-A illustrated in FIG. 21A is a cross-sectional part of the optical device 80 in which the first waveguide 82 is arranged. The optical device 80 includes a Si substrate 83, the clad 81 that is laminated on the Si substrate 83, the first assembly layers 85A, the second assembly layers 85B, and the third assembly layer 85C.

Each of the first assembly layers 85A is an assembly layer that is arranged between the associated second assembly layer 85B and the third assembly layer 85C. The third assembly layer 85C is an assembly layer that is arranged between the Si substrate 83 and the first assembly layers 85A.

In the first assembly layers 85A, the two second straight line waveguides 82B included in the first waveguide 82 are arranged, respectively. In the second assembly layers 85B, the two first straight line waveguides 82A included in the first waveguide 82 are arranged, respectively.

FIG. 21B is a diagram illustrating one example of a schematic cross-sectional portion taken along line B-B illustrated in FIG. 20. The schematic cross-sectional portion taken along line B-B illustrated in FIG. 21B is a cross-sectional part of the optical device 80 in which the adiabatic conversion unit 85 is arranged. The optical device 80 includes the Si substrate 83, the clad 81 that is laminated on the Si substrate 83, the first assembly layers 85A, the second assembly layers 85B, and the third assembly layer 85C.

In the first assembly layers 85A, the two second straight line waveguides 82B included in the first waveguide 82 are arranged, respectively. In the second assembly layers 85B, the two first straight line waveguides 82A included in the first waveguide 82 are arranged, respectively. In the third assembly layer 85C, the first tapered waveguide 84A included in the second waveguide 84 is arranged.

FIG. 21C is a diagram illustrating one example of a schematic cross-sectional portion taken along line C-C illustrated in FIG. 20. The schematic cross-sectional portion taken along the line C-C illustrated in FIG. 21C is a cross-sectional part of the optical device 80 in which the straight line waveguides 84B included in the second waveguide 84 are arranged. The optical device 80 includes the Si substrate 83, the clad 81 that is laminated on the Si substrate 83, the first assembly layers 85A, the second assembly layers 85B, and the third assembly layer 85C. In the third assembly layer 85C, the straight line waveguide 84B included in the second waveguide 84 is arranged.

The start point of the adiabatic conversion unit 85 is a start point of the first tapered waveguide 84A that is included in the second waveguide 84 and that is arranged between the two first straight line waveguides 82A and between the two second straight line waveguides 82B. The end point of the adiabatic conversion unit 85 is an end point of the first tapered waveguide 84A that is included in the second waveguide 84 and that is arranged between the two first straight line waveguides 82A and between the two second straight line waveguides 82B.

In the adiabatic conversion unit 85 according to the comparative example, the first tapered waveguide 84A is arranged between the two first straight line waveguides 82A (the two second straight line waveguides 82B), so that light is adiabatically transitioned from the first straight line waveguides 82A (the second straight line waveguides 82B) to the first tapered waveguide 84A. As a result, a discontinuous portion is not present in the first waveguide 82, so that it is possible to suppress an occurrence of an optical radiation loss and an optical reflection loss.

However, in the adiabatic conversion unit 85, confinement of light in the two first straight line waveguides 82A and the two second straight line waveguides 82B is weak, and thus, a radiation loss at the start point of the first tapered waveguide 84A included in the first waveguide 82 is increased. As a result, the size of parts is increased because the length of the adiabatic conversion unit 85, in which the second waveguide 84 and the first waveguide 82 are arranged side by side in a separated manner, is needed to some extent.

Preferred embodiments of the present invention will be explained with reference to accompanying drawings. Furthermore, the present invention is not limited to the embodiments. In addition, the embodiments described below may also be used in any appropriate combination as long as the embodiments do not conflict with each other.

### (a) First Embodiment

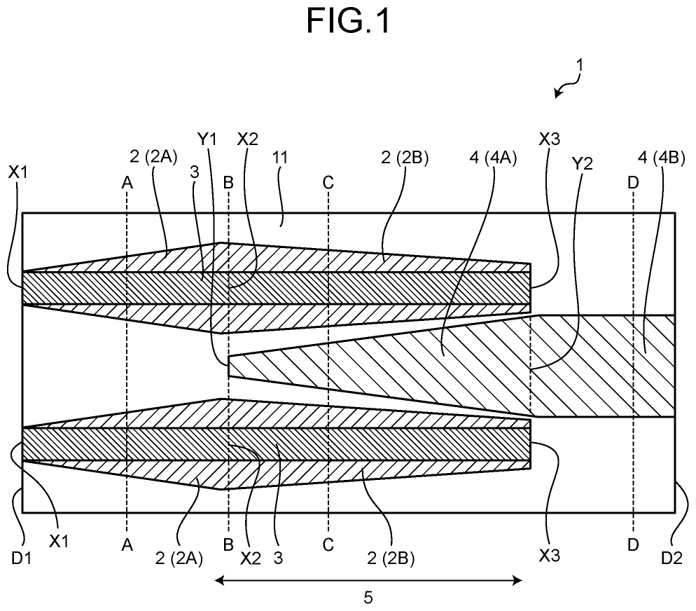

FIG. 1 is a diagram illustrating one example of an optical device 1 according to a first embodiment. The optical device 1 illustrated in FIG. 1 is a substrate type optical waveguide element that is optically coupled to the core of the optical fiber. The optical device 1 includes a first waveguide 2, a second waveguide 3, a third waveguide 4, and a clad 11 that covers the first waveguide 2, the second waveguide 3, and the third waveguide 4. Furthermore, the optical device 1 includes an adiabatic conversion unit 5 that allows portions among the first waveguide 2 and the second waveguide 3, and the third waveguide 4 to be adiabatically and optically transitioned.

The first waveguide 2 is, for example, a Silicon Nitride (SiN) waveguide that includes two first tapered waveguides 2A and two second tapered waveguides 2B. The first waveguide 2 is made of, for example, Si₃N₄ (hereinafter, simply referred to as SiN), and the material refractive index of SiN is 1.99 in the case where the optical wavelength is 1.55 μm. Each of the first tapered waveguides 2A is a waveguide that has a structure in which the waveguide width is gradually wider from a start point X1 toward an end point X2. Each of the second tapered waveguides 2B is a waveguide that has a structure in which the waveguide width is gradually narrower from a start point X2 toward an end point X3. By connecting the end point X2 of each of the first tapered waveguides 2A to the start point X2 of each of the second tapered waveguides 2B, a portion between each of the first tapered waveguides 2A and the associated second tapered waveguide 2B is connected. The thickness of the core of each of the first tapered waveguides 2A is set to be the same as that of each of the second tapered waveguides 2B. The start point X1 of the first waveguide 2 starts at the chip end surface D1 of the optical device 1 that is optically coupled to the core of the optical fiber.

The second waveguide 3 is a straight line waveguide that is arranged on the first waveguide 2. The second waveguide 3 is, for example, a Silicon Nitride (SiN) waveguide. In the second waveguide 3, the material refractive index of SiN is 1.99 in the case where the optical wavelength is 1.55 μm.

The third waveguide 4 is, for example, a Silicon (Si) waveguide that includes a third tapered waveguide 4A, and a straight line waveguide 4B that is connected to the third tapered waveguide 4A. In the third waveguide 4, the material refractive index of Si is 3.48 in the case where the optical wavelength is 1.55 μm. The material refractive index of SiN is smaller than the material refractive index of Si. The third tapered waveguide 4A is a waveguide that has a tapered structure in which the waveguide width is gradually wider from the start point Y1 toward the end point Y2. The straight line waveguide 4B is a waveguide in which the waveguide width from the start point Y2 toward the end point is constant. The thickness of the core of the straight line waveguide 4B is set to be the same as that of the third tapered waveguide 4A. The end point of the straight line waveguide 4B included in the third waveguide 4 ends, as the end point, at the chip end surface D2 that is located opposite the chip end surface D1 of the optical device 1.

The clad 11 is a layer that is made of, for example, SiO₂. The material refractive index of SiO₂ is 1.44 in the case where the optical wavelength is 1.55 μm.

The adiabatic conversion unit 5 is constituted such that the third tapered waveguide 4A is arranged, in a separated manner, between the two second tapered waveguides 2B and between the two second waveguides 3. In addition, even if the first waveguides 2 are not located directly above the second waveguides 3, the mode field is present across a portion that is located mainly around the two second tapered waveguides 2B and the two second waveguides 3, so that light is adiabatically transitioned from the first waveguide 2 and the second waveguide 3 to the third waveguide 4.

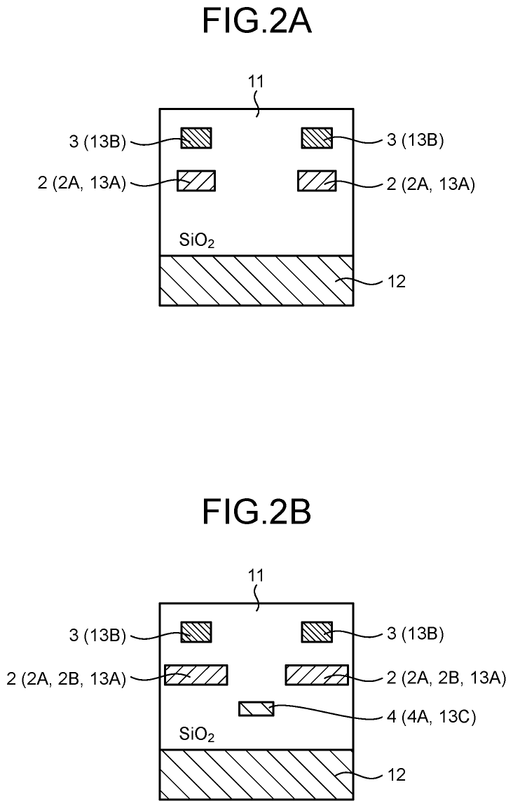

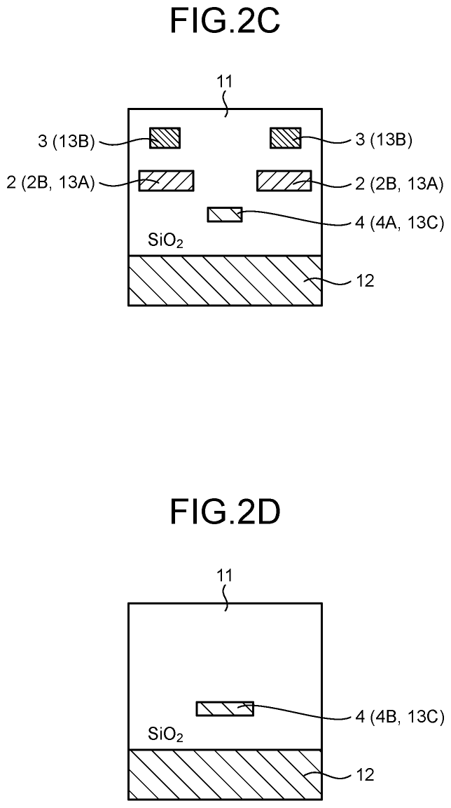

The adiabatic conversion unit 5 includes a start point X2 (Y1), an end point Y2, and an intermediate portion that is located between the start point X2 (Y1) and the end point Y2. FIG. 2A is a diagram illustrating one example of a schematic cross-sectional portion taken along line A-A illustrated in FIG. 1. The schematic cross-sectional portion taken along the line A-A illustrated in FIG. 2A is a cross-sectional part of the optical device 1 in which the two first tapered waveguides 2A included in the first waveguide 2 are arranged. The optical device 1 includes the clad 11, a Si substrate 12, first assembly layers 13A, second assembly layers 13B, and a third assembly layer 13C. Each of the first assembly layer 13A is an assembly layer that is formed on the Si substrate 12 on a side closer to the Si substrate 12. Each of the second assembly layers 13B is an assembly layer that is formed on a side away from the Si substrate 12. The third assembly layer 13C is an assembly layer that is located between the Si substrate 12 and the first assembly layer 13A. In each of the first assembly layers 13A, the respective first tapered waveguide 2A included in the first waveguide 2 is arranged. In each of the second assembly layers 13B, the respective second waveguide 3 is arranged.

FIG. 2B is a diagram illustrating one example of a schematic cross-sectional portion taken along line B-B illustrated in FIG. 1. The schematic cross-sectional portion taken along the line B-B illustrated in FIG. 2B is a cross-sectional part of the optical device 1 in which the start point of the adiabatic conversion unit 5 is arranged. The optical device 1 includes the clad 11, the Si substrate 12, the first assembly layers 13A, the second assembly layers 13B, and the third assembly layer 13C. In each of the first assembly layer 13A, a connection portion between each of the first tapered waveguides 2A and the associated second tapered waveguide 2B that are included in the first waveguide 2 is arranged. In each of the second assembly layers 13B, the associated second waveguide 3 is arranged. In the third assembly layer 13C, the third tapered waveguide 4A included in the third waveguide 4 is arranged. The adiabatic conversion unit 5 has a structure in which the third tapered waveguide 4A is disposed between the two second tapered waveguides 2B side by side.

FIG. 2C is a diagram illustrating one example of a schematic cross-sectional portion taken along line C-C illustrated in FIG. 1. The schematic cross-sectional portion taken along the line C-C illustrated in FIG. 2C is a cross-sectional part of the optical device 1 in which the end point of the adiabatic conversion unit 5 is arranged. The optical device 1 includes the clad 11, the Si substrate 12, the first assembly layers 13A, the second assembly layers 13B, and the third assembly layer 13C. In each of the first assembly layers 13A, the associated second tapered waveguide 2B included in the first waveguide 2 is arranged. In each of the second assembly layers 13B, the associated second waveguide 3 is arranged. In the third assembly layer 13C, the third tapered waveguide 4A included in the third waveguide 4 is arranged.

FIG. 2D is a diagram illustrating one example of a schematic cross-sectional portion taken along line D-D illustrated in FIG. 1. The schematic cross-sectional portion taken along the line D-D illustrated in FIG. 2D is a cross-sectional part of the optical device 1 in which the straight line waveguide 4B included in the third waveguide 4 is arranged. The optical device 1 includes the clad 11, the Si substrate 12, the first assembly layers 13A, the second assembly layers 13B, and the third assembly layer 13C. In the third assembly layer 13C, the straight line waveguide 4B included in the third waveguide 4 is arranged.

In the optical device 1 according to the first embodiment, the waveguide width of the two first tapered waveguides 2A included in the first waveguide 2 is made gradually wider, so that it is possible to strongly confine light. As a result, a radiation loss at the leading end of the third waveguide 4 at the start point of the adiabatic conversion unit 5 is decreased, so that it is possible to reduce the length of the adiabatic conversion unit 5. However, if the confinement of the first waveguide 2 remains strong, the conversion efficiency of the adiabatic conversion unit 5 varies in accordance with a wavelength or polarization, so that the dependence property of the wavelength and the polarization with respect to the conversion efficiency is increased.

Accordingly, in the adiabatic conversion unit 5 included in the optical device 1, the waveguide width of the two first tapered waveguides 2A included in the first waveguide 2 is made gradually narrower, it is possible to reduce the dependence property of the wavelength and the polarization with respect to the conversion efficiency.

In the adiabatic conversion unit 5, the third tapered waveguide 4A is arranged between the two second tapered waveguides 2B (the second waveguides 3), so that light is adiabatically transitioned from the second tapered waveguides 2B (the second waveguides 3) to the third tapered waveguide 4A. As a result, a discontinuous portion is not present in the interior of the first waveguide 2, so that it is possible to suppress an occurrence of a radiation loss and a reflection loss of light.

In the optical device 1, the two first waveguides 2 are arranged in the respective first assembly layers 13A on the chip end surface D1 side, and the two second waveguides 3 are arranged in the respective second assembly layers 13B on the chip end surface D1 side. As a result, it is possible to suppress a coupling loss with the optical fiber to some extent by bringing the mode field of each of the first waveguide 2 and the second waveguide 3 closer to the mode field of the optical fiber.

In other words, in the optical device 1, it is possible to suppress a radiation loss and a reflection loss in a section to the adiabatic conversion unit while reducing a coupling loss with the fiber at the chip end surface.

However, in the optical device 1 according to the first embodiment, the structure is constituted such that a space between the start points X1 of the two first tapered waveguides 2A that are optically coupled to the core of the optical fiber is slightly made narrow. As a result, the mode field of the optical device 1 is small at the chip end surface D1, and the mode field of the core of the optical fiber is large, and it is thus conceivable that the coupling efficiency of the optical device 1 with the core of the optical fiber is decreased. Accordingly, as compared to the optical device 1, an embodiment in which the coupling efficiency with the core of the optical fiber is able to be increased will be described below as a second embodiment.

### (b) Second Embodiment

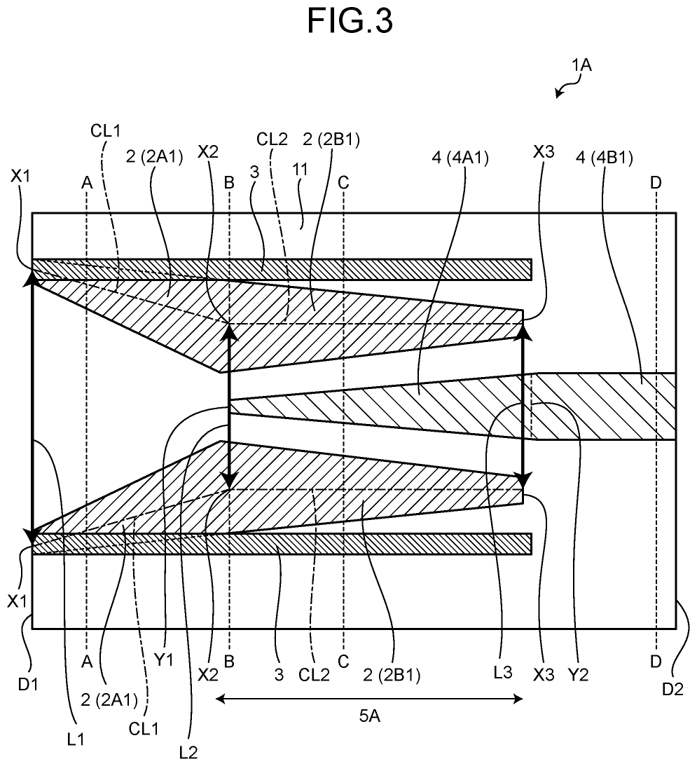

FIG. 3 is a diagram illustrating one example of an optical device 1A according to the second embodiment. In addition, by assigning the same reference numerals to components having the same configuration as those in the optical device 1 according to the first embodiment, overlapped descriptions of the configuration and the operation thereof will be omitted. The first waveguide 2 is, for example, a SiN waveguide that includes two first tapered waveguides 2A1 and two second tapered waveguides 2B1. The first waveguide 2 is made of, for example, SiN, and the material refractive index of SiN is 1.99 in the case where the optical wavelength is 1.55 μm. Each of the first tapered waveguides 2A1 is a waveguide having a structure in which the waveguide width is gradually wider from the start point X1 toward the end point X2. Each of the second tapered waveguides 2B1 is a waveguide in which the waveguide width is gradually narrower from the start point X2 toward the end point X3. By connecting the end point X2 of each of the first tapered waveguides 2A1 and the start point X2 of each of the second tapered waveguides 2B1, a portion between each of the first tapered waveguides 2A1 and the associated second tapered waveguide 2B1 is connected. The thickness of the core of each of the first tapered waveguides 2A1 is set to be the same as that of each of the second tapered waveguides 2B1. The start point X1 of the first waveguide 2 starts at the chip end surface D1 of the optical device 1 that is optically coupled to the core of the optical fiber.

The second waveguide 3 is a straight line waveguide that is arranged on the first waveguide 2. The second waveguide 3 is, for example, a SiN waveguide. In the second waveguide 3, the material refractive index of SiN is 1.99 in the case where the optical wavelength is 1.55 μm.

The third waveguide 4 is, for example, a Si waveguide that includes a third tapered waveguide 4A1, and a straight line waveguide 4B1 that is connected to the third tapered waveguide 4A1. In the third waveguide 4, the material refractive index of Si is 3.48 in the case where the optical wavelength is 1.55 μm. The material refractive index of SiN is smaller than the material refractive index of Si. The third tapered waveguide 4A1 is a waveguide having a tapered structure in which the waveguide width is gradually wider from the start point Y1 toward the end point Y2. The straight line waveguide 4B1 is a waveguide in which the waveguide width from the start point Y2 toward the end point is constant. The thickness of the core of the straight line waveguide 4B1 is set to be the same as that of the third tapered waveguide 4A1. The end point of the straight line waveguide 4B1 included in the third waveguide 4 ends, as the end point, at the chip end surface D2 that is located opposite the chip end surface D1 of the optical device 1.

A line connecting between the core center of each of the first tapered waveguides 2A1 at the associated start point X1 and the core center of each of the first tapered waveguides 2A1 at the associated end point X2 is denoted by a first center line CL1. In addition, the end point X2 of each of the first tapered waveguides 2A1 and the start point X2 of the associated second tapered waveguides 2B1 are the same. A line connecting between the core center of each of the second tapered waveguides 2B1 at the start point X2 and the core center of the associated the second tapered waveguides 2B1 at the end point X3 is denoted by a second center line CL2.

In addition, a distance between the core center at the start point X1 of one of the first tapered waveguides 2A1 and the core center at the start point X1 of the other of the first tapered waveguides 2A1 is denoted by a first space L1. In other words, the first space L1 is a space between the two first waveguides 2 at the start points X1 of the respective first tapered waveguides 2A1. A distance between the core center at the end point X2 of one of the first tapered waveguides 2A1 and the core center at the end point X2 of the other of the first tapered waveguides 2A1 is denoted by a second space L2. In other words, the second space L2 is a space between the two first waveguides 2 at the connection portion between each of the first tapered waveguides 2A1 and the associated second tapered waveguide 2B1. A distance between the core center at the end point X3 of one of the second tapered waveguides 2B1 and the core center at the end point X3 of the other of the second tapered waveguides 2B1 is denoted by a third space L3. Then, the relationship among the first space L1, the second space L2, and the third space L3 is represented by L1>L2, L1>L3, and L2=L3. In other words, the first waveguide 2 is a structure in which the first space L1 is larger than the second space L2.

The optical device 1A is constituted to have a structure such that the distance between the two first tapered waveguides 2A1 is set to be the first space L1 in order to widen a portion of the first waveguide 2 that is located at the chip end surface D1 and that is optically coupled to the core of the optical fiber, and in order to bring the mode field of the optical device 1A closer to the mode field of the core of the optical fiber. Consequently, as a result of the mode field of the optical device 1A at the chip end surface D1 being closer to the mode field of the core of the optical fiber, the coupling efficiency of the optical device 1A with the core of the optical fiber is improved.

The third waveguide 4 includes the third tapered waveguide 4A1 and the straight line waveguide 4B1 that is connected to the third tapered waveguide 4A1. The third tapered waveguide 4A1 is a waveguide that has a tapered structure in which the waveguide width is gradually wider from the start point Y1 toward the end point Y2. In other words, the third tapered waveguide 4A1 has a structure in which the waveguide width is gradually wider as the third tapered waveguide 4A1 is closer to the straight line waveguide 4B1. The straight line waveguide 4B1 is a waveguide in which the waveguide width is constant from a start point Y2 toward the end point. In other words, the straight line waveguide 4B1 is a waveguide that is connected to the third tapered waveguide 4A1 on a side opposite to the side on which the first tapered waveguides 2A1 are provided. The thickness of the core of the third tapered waveguide 4A1 is set to be the same as that of the straight line waveguide 4B1. The end point of the straight line waveguide 4B1 included in the third waveguide 4 ends, as the end point, at the chip end surface D2 that is disposed opposite the chip end surface D1 of the optical device 1A.

An adiabatic conversion unit 5A includes the two second tapered waveguides 2B1 included in the first waveguide 2, and the third tapered waveguide 4A1 included in the third waveguide 4. The adiabatic conversion unit 5A is constituted such that the third tapered waveguide 4A1 is arranged, between the two second tapered waveguides 2B1, below the second tapered waveguides 2B1 side by side in a state in which the third tapered waveguide 4A1 is separated from the second tapered waveguides 2B1. In addition, in the first waveguide 2, the mode field is present across a portion that is located mainly around the two second tapered waveguides 2B1, so that light is adiabatically transitioned from the first waveguide 2 to the third waveguide 4.

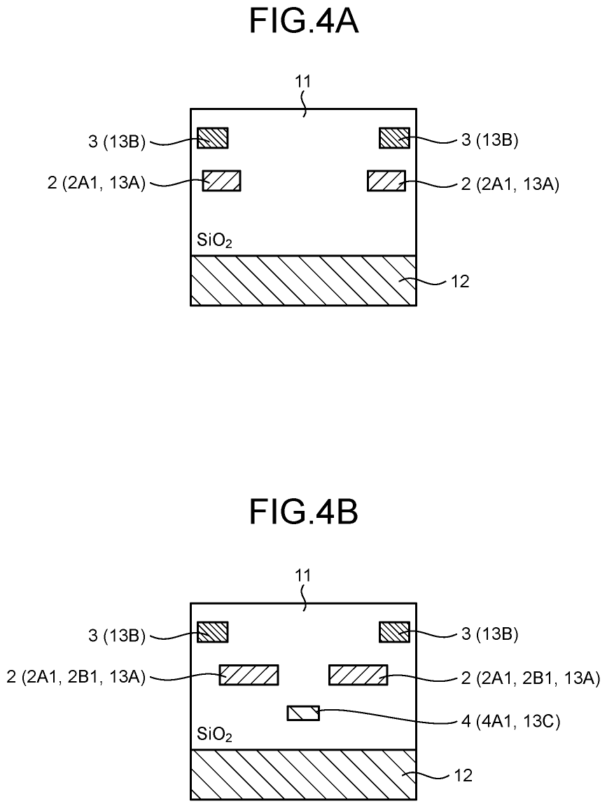

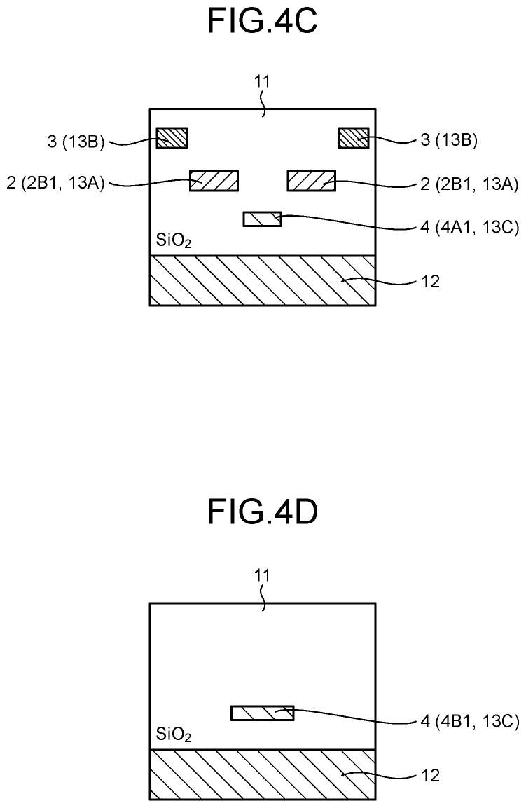

The adiabatic conversion unit 5A includes the start point X2 (Y1), an end point X3 (Y2), and an intermediate portion that is located between the start point X2 (Y1) and the end point X3 (Y2). FIG. 4A is a diagram illustrating one example of a schematic cross-sectional portion taken along line A-A illustrated in FIG. 3. The schematic cross-sectional portion taken along the line A-A illustrated in FIG. 4A is a cross-sectional part of the optical device 1A in which the two first tapered waveguides 2A1 included in the first waveguide 2 are disposed. The optical device 1A includes the clad 11, the Si substrate 12, the first assembly layers 13A, the second assembly layers 13B, and the third assembly layer 13C. In each of the first assembly layers 13A, the associated first tapered waveguide 2A1 included in the first waveguide 2 is arranged. In each of the second assembly layers 13B, the associated second waveguide 3 is arranged.

FIG. 4B is a diagram illustrating one example of a schematic cross-sectional portion taken along line B-B illustrated in FIG. 3. The schematic cross-sectional portion taken along the line B-B illustrated in FIG. 4B is a cross-sectional part of the optical device 1A in which the start point of the adiabatic conversion unit 5 is arranged. The optical device 1A includes the clad 11, the Si substrate 12, the first assembly layers 13A, the second assembly layers 13B, and the third assembly layer 13C. In each of the first assembly layers 13A, a connection portion between each of the first tapered waveguides 2A1 and the associated second tapered waveguide 2B1 that are included in the first waveguide 2 is arranged. In each of the second assembly layers 13B, the associated second waveguide 3 is arranged. In the third assembly layer 13C, the third tapered waveguide 4A1 included in the third waveguide 4 is arranged. The adiabatic conversion unit 5A has a structure in which the third tapered waveguide 4A1 is disposed, between the two second tapered waveguides 2B1, side by side with the two second tapered waveguides 2B1.

FIG. 4C is a diagram illustrating one example of a schematic cross-sectional portion taken along line C-C illustrated in FIG. 3. The schematic cross-sectional portion taken along the line C-C illustrated in FIG. 4C is a cross-sectional part of the optical device 1A in which the end point of the adiabatic conversion unit 5A is arranged. The optical device 1A includes the clad 11, the Si substrate 12, the first assembly layers 13A, the second assembly layers 13B, and the third assembly layer 13C. In each of the first assembly layers 13A, the associated second tapered waveguide 2B1 included in the first waveguide 2 is arranged. In each of the second assembly layers 13B, the associated second waveguide 3 is arranged. In the third assembly layer 13C, the third tapered waveguide 4A1 included in the third waveguide 4 is arranged.

FIG. 4D is a diagram illustrating one example of a schematic cross-sectional portion taken along line D-D illustrated in FIG. 3. The schematic cross-sectional portion taken along the line D-D illustrated in FIG. 4D is a cross-sectional part of the optical device 1A in which the straight line waveguide 4B1 included in the third waveguide 4 is arranged. The optical device 1A includes the clad 11, the Si substrate 12, the first assembly layers 13A, the second assembly layers 13B, and the third assembly layer 13C. In the third assembly layer 13C, the straight line waveguide 4B1 included in the third waveguide 4 is arranged.

The start point of the adiabatic conversion unit 5A is a portion in which the start point X2 of each of the second tapered waveguides 2B1 and the start point Y1 of the third tapered waveguide 4A1 are arranged. The waveguide width at the start point X2 of the second tapered waveguide 2B1 is made wider than the waveguide width at the start point Y1 of the third tapered waveguide 4A1. The adiabatic conversion unit 5A has a structure in which the third tapered waveguide 4A1 is disposed, between the two second tapered waveguides 2B1, at a position below the two second tapered waveguides 2B1.

The end point of the adiabatic conversion unit 5A is a portion in which the end point X3 of each of the second tapered waveguides 2B1 and the end point Y2 of the third tapered waveguide 4A1 are arranged. The waveguide width of the second tapered waveguide 2B1 at the end point X3 is made narrower than the waveguide width of the third tapered waveguide 4A1 at the end point Y3.

In the adiabatic conversion unit 5A included in the optical device 1A according to the second embodiment, the third tapered waveguide 4A1 is arranged between the two second tapered waveguides 2B1, light is adiabatically transitioned between each of the second tapered waveguides 2B1 and the third tapered waveguide 4A1. As a result, a discontinuous portion is not present in the interior of the first waveguide 2, it is possible to suppress an occurrence of a radiation loss and a reflection loss in light.

In the optical device 1A, the waveguide width of each of the two first tapered waveguides 2A1 included in the first waveguide 2 is made gradually wider, so that it is possible to strongly confine light. As a result, a radiation loss at the leading end of the third waveguide 4 at the start point of the adiabatic conversion unit 5A is decreased, so that it is possible to shorten the length of the adiabatic conversion unit 5A.

Furthermore, in the optical device 1A, the waveguide width of each of the two second tapered waveguides 2B1 included in the first waveguide 2 is made gradually narrower, so that it is possible to suppress a decrease in the conversion efficiency while decreasing the dependence property of the wavelength and the polarization with respect to the conversion efficiency as a result of a reduction in the effective refractive index of the first waveguide 2.

Furthermore, in the optical device 1A, the structure has been constituted such that the space between the two first tapered waveguides 2A1 is gradually narrower from the start point X1 toward the end point X2. In the optical device 1A, a portion of the first waveguide 2 that is located at the chip end surface D1 and that is optically coupled to the core of the optical fiber is made wider, and the first space L1 is made wider than the second space L2. Consequently, as a result of the mode field of the optical device 1A at the chip end surface D1 being closer to the mode field of the core of the optical fiber, it is possible to improve the coupling efficiency of the optical device 1A with the core of the optical fiber and suppress an optical insertion loss.

For convenience of description, in the optical device 1A, the first space L1 is made longer than the second space L2. However, the first space L1 may be increased such that the mode field of the optical device 1A on the chip end surface D1 is made closer to the mode field of the core of the optical fiber, or the first space may be shorter than the second space.

In addition, in the optical device 1A according to the second embodiment, the relationship between the second space L2 and the third space L3 is indicated by L2=L3, so that the mode field of the adiabatic conversion unit 5A is large, and thus, it is not possible to bring the mode field of the adiabatic conversion unit 5A to be closer to the mode field of the straight line waveguide 4B1 that is included in the third waveguide 4 and that is optically coupled to the adiabatic conversion unit 5A. As a result, there may be a case in which a coupling loss occurs due to a mismatch of the mode field with the third waveguide 4 at the adiabatic conversion unit 5A. Accordingly, an embodiment of solving this circumstance will be described below as a third embodiment.

### (c) Third Embodiment

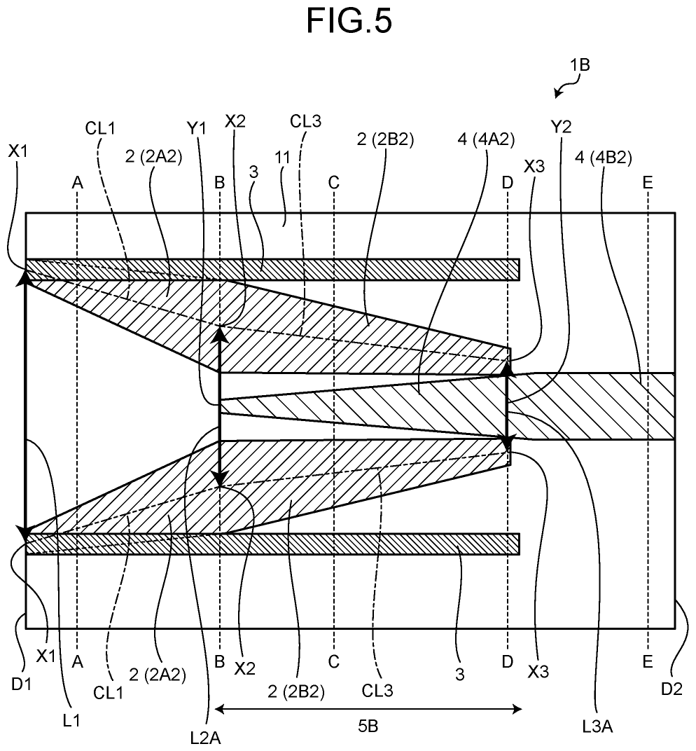

FIG. 5 is a diagram illustrating one example of an optical device 1B according to the third embodiment. In addition, by assigning the same reference numerals to components having the same configuration as those in the optical device 1A according to the second embodiment, overlapped descriptions of the configuration and the operation thereof will be omitted. The optical device 1B according to the third embodiment is different from the optical device 1A according to the second embodiment in that the second space L2 that is located at the start point X2 (Y1) of the adiabatic conversion unit 5A is made narrower than the third space L3 that is located at the end point X3 (Y2) of the adiabatic conversion unit 5A.

The first waveguide 2 includes two first tapered waveguides 2A2 and two second tapered waveguides 2B2. Each of the second tapered waveguides 2B2 is a waveguide having a tapered structure in which the waveguide width is gradually narrower from the start point X2 toward the end point X3. A line connecting between the core center of each of the first tapered waveguides 2A2 at the start point X1 and the core center of the associated first tapered waveguide 2A2 at the end point X2 is denoted by the first center line CL1. A line connecting between the core center of each of the second tapered waveguides 2B2 at the start point X2 and the core center of the associated second tapered waveguide 2B2 at the end point X3 is denoted by a third center line CL3.

A distance between the core center at the end point X2 of one of the first tapered waveguides 2A2 and the core center at the end point X2 of the other of the first tapered waveguides 2A2 is denoted by a second space L2A. A distance between the core center at the end point X3 of one of the second tapered waveguides 2B2 and the core center at the end point X3 at the other of the second tapered waveguides 2B2 is denoted by a third space L3A. Then, the relationship among the first space L1, the second space L2A, and the third space L3A is expressed by L1>L2A, L1>L3A, and L2A>L3A.

The optical device 1B is constituted to have a structure such that the distance between the two first tapered waveguides 2A2 is set to be the first space L1 in order to widen a portion of the first waveguide 2 that is located at the chip end surface D1 and that is optically coupled to the core of the optical fiber, and in order to bring the mode field of the optical device 1B closer to the mode field of the core of the optical fiber. Consequently, as a result of the mode field of the optical device 1B at the chip end surface D1 being closer to the mode field of the core of the optical fiber, the coupling efficiency of the optical device 1B with the core of the optical fiber is improved.

In an adiabatic conversion unit 5B, each of the two second tapered waveguides 2B2 is constituted to have a structure such that the third space L3A is made narrower than the second space L2A. As a result, the mode field of the adiabatic conversion unit 5B is closer to the mode field of a straight line waveguide 4B2 included in the third waveguide 4, so that it is possible to suppress a coupling loss with the third waveguide 4 occurring in the adiabatic conversion unit 5B.

The adiabatic conversion unit 5B includes the two second tapered waveguides 2B2 that are included in the first waveguide 2, and a third tapered waveguide 4A2 that is included in the third waveguide 4. The adiabatic conversion unit 5B is constituted by arranging the third tapered waveguide 4A2, between the two second tapered waveguides 2B2, below the second tapered waveguides 2B2 side by side with the second tapered waveguides 2B2 in a state in which the third tapered waveguide 4A2 is separated from the second tapered waveguide 2B2.

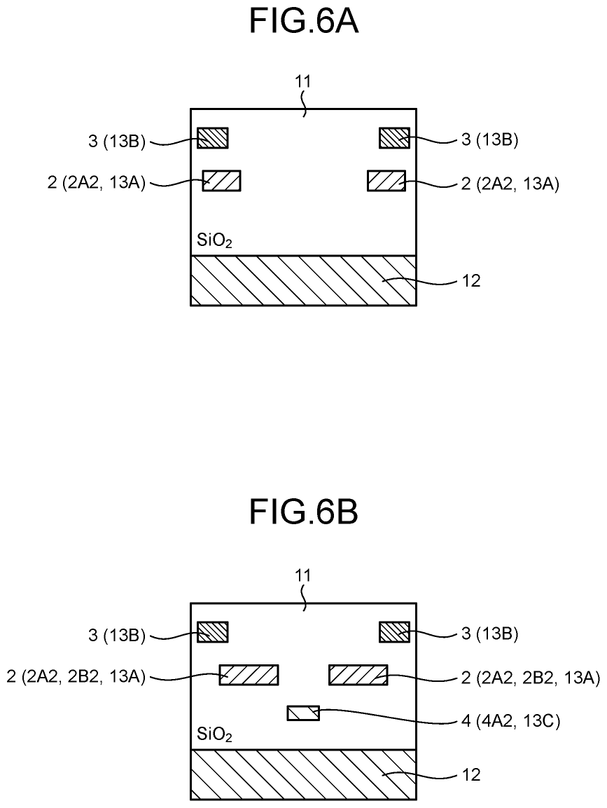

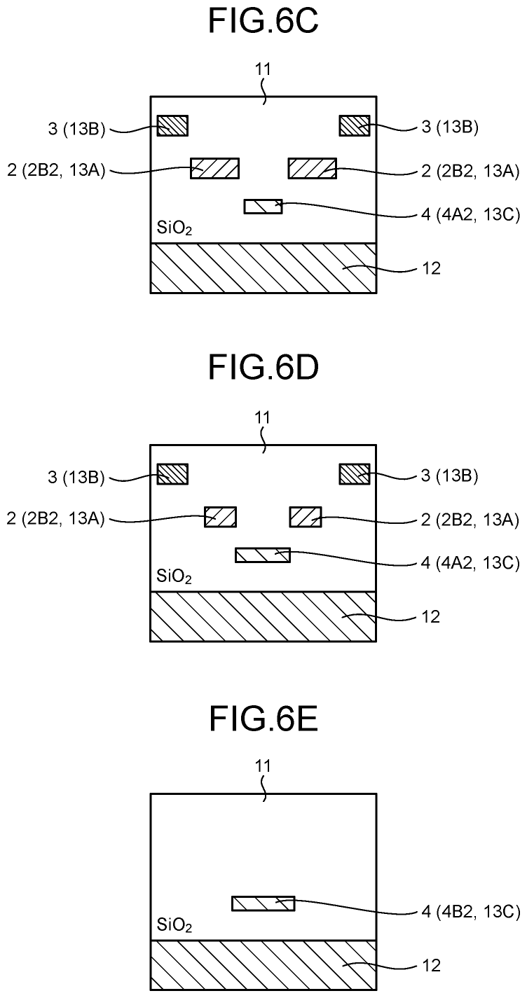

The adiabatic conversion unit 5B includes the start point X2 (Y1), the end point X3 (Y2), and an intermediate portion that is located between the start point X2 (Y1) and the end point X3 (Y2). FIG. 6A is a diagram illustrating one example of a schematic cross-sectional portion taken along line A-A illustrated in FIG. 5. The schematic cross-sectional portion taken along the line A-A illustrated in FIG. 6A is a cross-sectional part of the optical device 1B in which the two first tapered waveguides 2A2 included in the first waveguide 2 are arranged. The optical device 1B includes the clad 11, the Si substrate 12, the first assembly layers 13A, the second assembly layers 13B, and the third assembly layer 13C. In each of the first assembly layers 13A, the associated first tapered waveguide 2A2 included in the first waveguide 2 is arranged. In each of the second assembly layers 13B, the associated second waveguide 3 is arranged.

FIG. 6B is a diagram illustrating one example of a schematic cross-sectional portion taken along line B-B illustrated in FIG. 5. The schematic cross-sectional portion taken along the line B-B illustrated in FIG. 6B is a cross-sectional part of the optical device 1B in which the start point of the adiabatic conversion unit 5B is arranged. The optical device 1A includes the clad 11, the Si substrate 12, the first assembly layers 13A, the second assembly layers 13B, and the third assembly layer 13C. In each of the first assembly layer 13A, a connection portion between each of the first tapered waveguides 2A2 and the associated second tapered waveguide 2B2 that are included in the first waveguide 2 is arranged. In each of the second assembly layers 13B, the associated second waveguide 3 is arranged. In the third assembly layer 13C, the third tapered waveguide 4A2 included in the third waveguide 4 is arranged. The adiabatic conversion unit 5A has a structure in which the third tapered waveguide 4A2 is disposed between the two second tapered waveguides 2B2 side by side.

FIG. 6C is a diagram illustrating one example of a schematic cross-sectional portion taken along line C-C illustrated in FIG. 5. The schematic cross-sectional portion taken along the line C-C illustrated in FIG. 6C is a cross-sectional part of the optical device 1B in which an intermediate point of the adiabatic conversion unit 5B is arranged. The optical device 1A includes the clad 11, the Si substrate 12, the first assembly layers 13A, the second assembly layers 13B, and the third assembly layer 13C. In each of the first assembly layers 13A, the associated second tapered waveguide 2B2 included in the first waveguide 2 is arranged. In each of the second assembly layer 13B, the associated second waveguide 3 is arranged. In the third assembly layer 13C, the third tapered waveguide 4A2 included in the third waveguide 4 is arranged.

FIG. 6D is a diagram illustrating one example of a schematic cross-sectional portion taken along line D-D illustrated in FIG. 5. The schematic cross-sectional portion taken along the line D-D illustrated in FIG. 6D is a cross-sectional part of the optical device 1B in which the end point of the adiabatic conversion unit 5B is arranged. The optical device 1A includes the clad 11, the Si substrate 12, the first assembly layer 13A, the second assembly layer 13B, and the third assembly layer 13C. In each of the first assembly layers 13A, the associated second tapered waveguide 2B2 included in the first waveguide 2 is arranged. In each of the second assembly layers 13B, the associated second waveguide 3 is arranged. In the third assembly layer 13C, the third tapered waveguide 4A2 included in the third waveguide 4 is arranged.

FIG. 6E is a diagram illustrating one example of a schematic cross-sectional portion taken along line E-E illustrated in FIG. 5. The schematic cross-sectional portion taken along the line E-E illustrated in FIG. 6E is a cross-sectional part of the optical device 1B in which the straight line waveguide 4B2 included in the third waveguide 4 is arranged. The optical device 1B includes the clad 11, the Si substrate 12, the first assembly layers 13A, the second assembly layers 13B, and the third assembly layer 13C. In the third assembly layer 13C, the straight line waveguide 4B2 included in the third waveguide 4 is arranged.

The start point of the adiabatic conversion unit 5B is a portion in which the start point X2 of each of the second tapered waveguides 2B2 and the start point Y1 of the third tapered waveguide 4A2 are arranged. The waveguide width of each of the second tapered waveguides 2B2 at the start point X2 is made wider than the waveguide width of the third tapered waveguide 4A2 at the start point Y1. The adiabatic conversion unit 5B has a structure in which the third tapered waveguide 4A2 is disposed, between the two second tapered waveguides 2B2, side by side at a position below the two second tapered waveguides 2B2. The end point of the adiabatic conversion unit 5B is a portion in which the end point X3 of each of the second tapered waveguides 2B2 and the end point Y2 of the third tapered waveguide 4A2 are arranged.

The adiabatic conversion unit 5B included in the optical device 1B is constituted to have a structure in which the space between the second tapered waveguides 2B2 is gradually narrow such that the third space L3A between the two second tapered waveguides 2B2 at the respective end points X3 is made narrower than the second space L2A between the second tapered waveguides 2B2 at the respective start points X2. As a result, the mode field of the adiabatic conversion unit 5B is closer to the mode field of the straight line waveguide 4B2 while suppressing a decrease in the conversion efficiency occurring at the adiabatic conversion unit 5B, so that it is possible to improve the coupling loss with the third waveguide 4.

In the adiabatic conversion unit 5B, the effective refractive index is controlled by changing the first waveguide 2 to have a tapered shape and the space between the second tapered waveguides 2B2 is made gradually narrow, so that the mode field of light propagating through the first waveguide 2 is controlled. The effective refractive index and the mode field of light guided in the first waveguide 2 are made closer to the effective refractive index and the mode field propagating through the third waveguide 4. As a result, it is possible to shorten the length of the adiabatic conversion unit 5B while decreasing the coupling loss between the first waveguide 2 and the third waveguide 4.

In addition, a case has been described as an example in which, in the optical device 1B according to the third embodiment, each of the second waveguides 3 is a single straight line waveguide; however, the example is not limited to this, and two straight line waveguides may be used for the structure, and an embodiment thereof will be described below as a fourth embodiment.

### (d) Fourth Embodiment

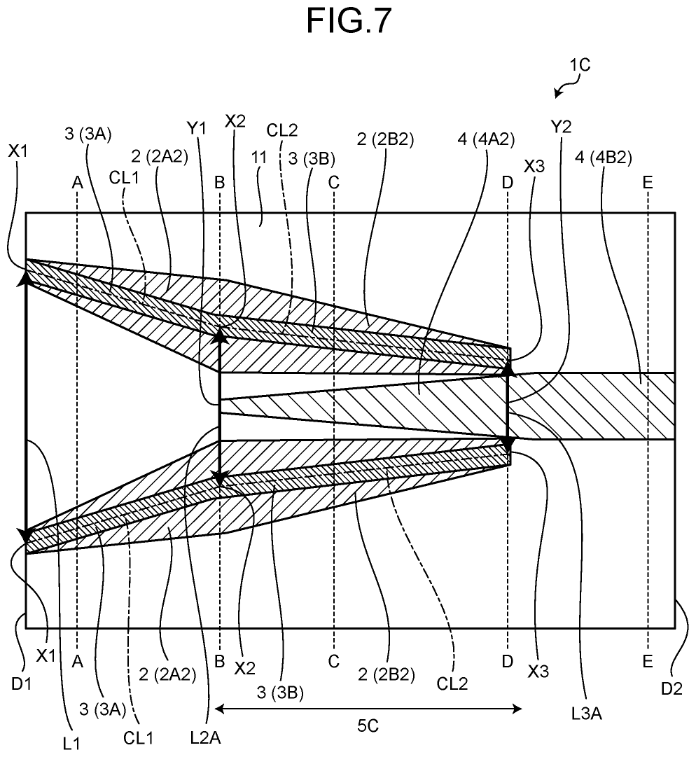

FIG. 7 is a diagram illustrating one example of an optical device 1C according to the fourth embodiment. In addition, by assigning the same reference numerals to components having the same configuration as those in the optical device 1B according to the third embodiment, overlapped descriptions of the configuration and the operation thereof will be omitted. The optical device 1C according to the fourth embodiment is different from the optical device 1B according to the third embodiment in that each of the second waveguides 3 is constituted by using two straight line waveguides. Each of the second waveguides 3 includes a first straight line waveguide 3A, and a second straight line waveguide 3B that is connected to the first straight line waveguide 3A. Each of the first straight line waveguides 3A is arranged on the first center line CL1 of the associated first tapered waveguide 2A2. Each of the second straight line waveguides 3B is arranged on the second center line CL2 of the associated second tapered waveguide 2B2.

In an adiabatic conversion unit 5C, the two second tapered waveguides 2B2 is constituted such that the third space L3A is narrower than the second space L2A. As a result, the mode field of the adiabatic conversion unit 5C is closer to the mode field of the straight line waveguide 4B2 included in the third waveguide 4, so that it is possible to suppress a coupling loss with the third waveguide 4 occurring in the adiabatic conversion unit 5C.

The adiabatic conversion unit 5C includes the two second tapered waveguides 2B2 included in the first waveguide 2, and the third tapered waveguide 4A2 included in the third waveguide 4. The adiabatic conversion unit 5C is constituted such that the third tapered waveguide 4A2 is arranged between the two second tapered waveguides 2B2, below the second tapered waveguides 2B2 side by side in a state in which the third tapered waveguide 4A2 is separated from the second tapered waveguides 2B2.

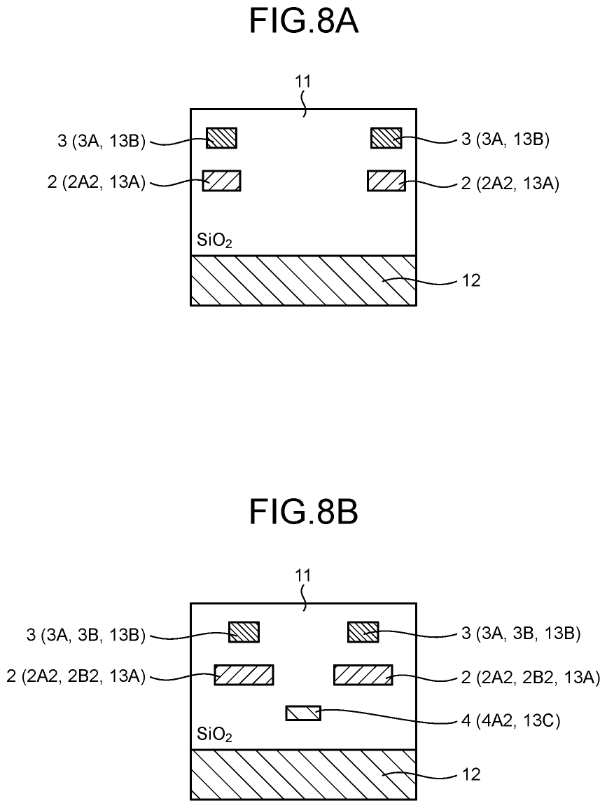

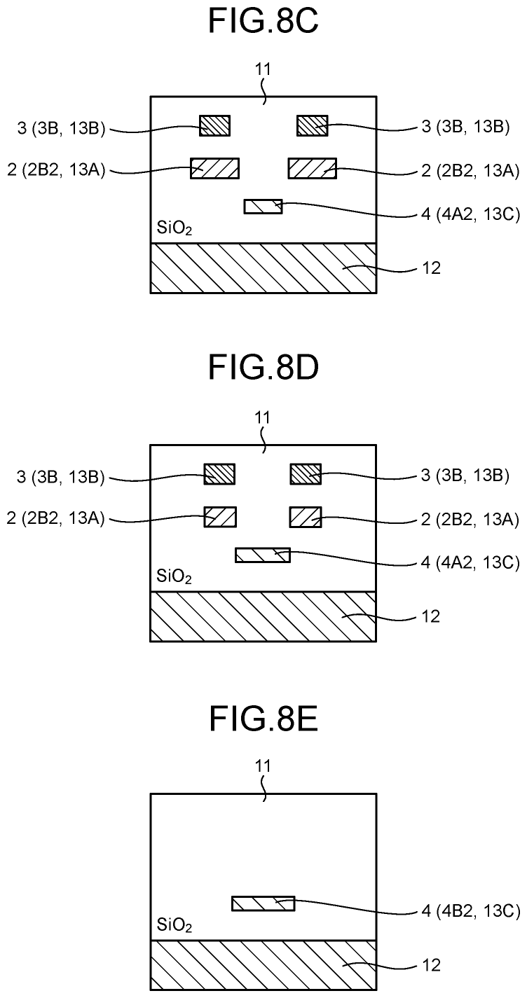

The adiabatic conversion unit 5C includes the start point X2 (Y1), the end point X3 (Y2), and an intermediate portion that is located between the start point X2 (Y1) and the end point X3 (Y2). FIG. 8A is a diagram illustrating one example of a schematic cross-sectional portion taken along line A-A illustrated in FIG. 7. The schematic cross-sectional portion taken along the line A-A illustrated in FIG. 8A is a cross-sectional part of the optical device 1C in which the two first tapered waveguides 2A2 included in the first waveguide 2 are arranged. The optical device 1C includes the clad 11, the Si substrate 12, the first assembly layers 13A, the second assembly layers 13B, and the third assembly layer 13C. In each of the first assembly layers 13A, the associated first tapered waveguide 2A2 included in the first waveguide 2 is arranged. In each of the second assembly layers 13B, the associated first straight line waveguide 3A included in the second waveguide 3 is arranged.

FIG. 8B is a diagram illustrating one example of a schematic cross-sectional portion taken along line B-B illustrated in FIG. 7. The schematic cross-sectional portion taken along the line B-B illustrated in FIG. 8B is a cross-sectional part of the optical device 1C in which the start point of the adiabatic conversion unit 5C is arranged. The optical device 1C includes the clad 11, the Si substrate 12, the first assembly layers 13A, the second assembly layers 13B, and the third assembly layer 13C. In each of the first assembly layers 13A, a connection portion between each of the first tapered waveguides 2A2 and the associated second tapered waveguide 2B2 that are included in the first waveguide 2 is arranged. In each of the second assembly layers 13B, a connection portion between each of the first straight line waveguides 3A and the associated second straight line waveguide 3B that are included in the second waveguide 3 is arranged In the third assembly layer 13C, the third tapered waveguide 4A2 included in the third waveguide 4 is arranged. The adiabatic conversion unit 5C has a structure in which the third tapered waveguide 4A2 is disposed between the two second tapered waveguides 2B2 side by side.

FIG. 8C is a diagram illustrating one example of a schematic cross-sectional portion taken along line C-C illustrated in FIG. 7. The schematic cross-sectional portion taken along the line C-C illustrated in FIG. 8C is a cross-sectional part of the optical device 1C in which an intermediate point of the adiabatic conversion unit 5C is arranged. The optical device 1C includes the clad 11, the Si substrate 12, the first assembly layers 13A, the second assembly layers 13B, and the third assembly layer 13C. In each of the first assembly layers 13A, the associated second tapered waveguide 2B2 included in the first waveguide 2 is arranged. In each of the second assembly layers 13B, the associated second straight line waveguide 3B included in the second waveguide 3 is arranged. In the third assembly layer 13C, the third tapered waveguide 4A2 included in the third waveguide 4 is arranged.

FIG. 8D is a diagram illustrating one example of a schematic cross-sectional portion taken along line D-D illustrated in FIG. 7. The schematic cross-sectional portion taken along the line D-D illustrated in FIG. 8D is a cross-sectional part of the optical device 1C in which the end point of the adiabatic conversion unit 5C is arranged. The optical device 1C includes the clad 11, the Si substrate 12, the first assembly layers 13A, the second assembly layers 13B, and the third assembly layer 13C. In each of the first assembly layers 13A, the associated second tapered waveguide 2B2 included in the first waveguide 2 is arranged. In each of the second assembly layers 13B, the associated second straight line waveguide 3B included in the second waveguide 3 is arranged. In the third assembly layer 13C, the third tapered waveguide 4A2 included in the third waveguide 4 is arranged.

FIG. 8E is a diagram illustrating one example of a schematic cross-sectional portion taken along line E-E illustrated in FIG. 7. The schematic cross-sectional portion taken along the line E-E illustrated in FIG. 8E is a cross-sectional part of the optical device 1C in which the straight line waveguide 4B2 included in the third waveguide 4 is arranged. The optical device 1C includes the clad 11, the Si substrate 12, the first assembly layers 13A, the second assembly layers 13B, and the third assembly layer 13C. In the third assembly layer 13C, the straight line waveguide 4B2 included in the third waveguide 4 is arranged.

The start point of the adiabatic conversion unit 5C is a portion at which the start point X2 of each of the second tapered waveguides 2B2 and the start point Y1 of the third tapered waveguide 4A2 are arranged. The waveguide width of the start point X2 of each of the second tapered waveguides 2B2 is made wider than the waveguide width of the start point Y1 of the third tapered waveguide 4A2. The adiabatic conversion unit 5C has a structure in which the third tapered waveguide 4A2 is disposed, between the two second tapered waveguides 2B2, side by side at a position below the two second tapered waveguides 2B2. The end point of the adiabatic conversion unit 5C is a portion in which the end point X3 of each of the second tapered waveguides 2B2 and the end point Y2 of the third tapered waveguide 4A2 are arranged.

The adiabatic conversion unit 5C included in the optical device 1C has a structure in which the space between the second tapered waveguide 2B2 is gradually narrow such that the third space L3A between the two second tapered waveguides 2B2 at the respective end points X3 is made narrower than the second space L2A between the second tapered waveguides 2B2 at the respective start points X2. As a result, the mode field of the adiabatic conversion unit 5C is closer to the mode field of the straight line waveguide 4B2 while suppressing a decrease in the conversion efficiency occurring at the adiabatic conversion unit 5C, so that it is possible to improve the coupling loss with the third waveguide 4.

In the adiabatic conversion unit 5C, the effective refractive index is controlled by changing the first waveguide 2 to have a tapered shape and the space between the second tapered waveguides 2B2 is made gradually narrow, so that the mode field of light propagating through the first waveguide 2 is controlled. The effective refractive index and the mode field of light guided in the first waveguide 2 are made closer to effective refractive index and the mode field of light propagating through the third waveguide 4. As a result, it is possible to shorten the length of the adiabatic conversion unit 5C while decreasing the coupling loss between the first waveguide 2 and the third waveguide 4.

The optical device 1C is constituted to have a structure such that the space between the two first straight line waveguides 3A at the respective start points X1 is set to be the first space L1, the space between the two second straight line waveguides 3B at the respective start points X2 is set to be the second space L2A, and the space between the two second straight line waveguides 3B at the respective end points X3 is set to be the third space L3A. As a result, it is possible to reduce a propagation loss in light.

In addition, in the adiabatic conversion unit 5C included in the optical device 1C according to the fourth embodiment, the end point X3 of each of the second tapered waveguides 2B2 included in the first waveguide 2 is terminated in a state in which the end point X3 is located closer to the third waveguide 4, so that refractive index distribution is sharply changed as a result of the first waveguide 2 being terminated at the end point of the adiabatic conversion unit 5C. Consequently, a scattering loss of light occurs caused by a change in a cross-sectional shape at the end point of the adiabatic conversion unit 5C. Accordingly, in order to cope with the circumstances, an embodiment thereof will be described below as a fifth embodiment.

### (e) Fifth Embodiment

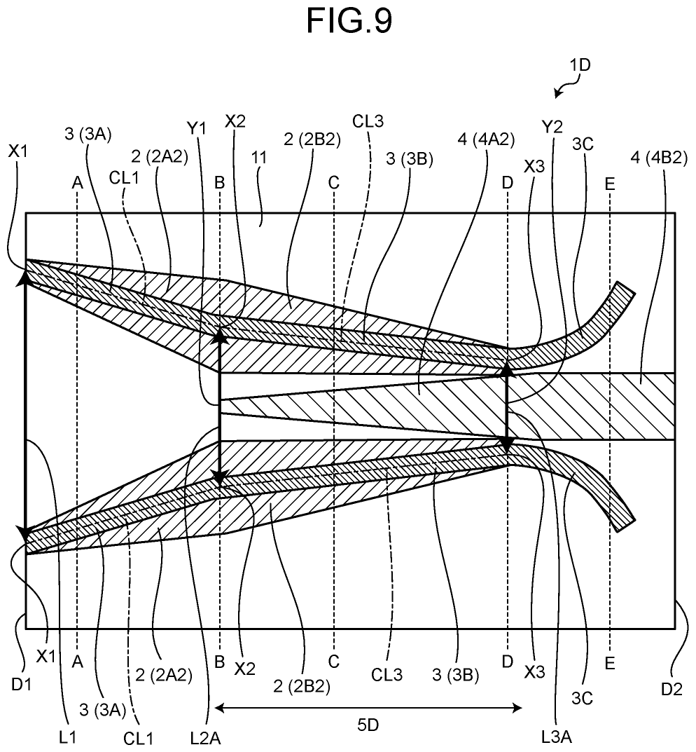

FIG. 9 is a diagram illustrating one example of an optical device 1D according to the fifth embodiment. In addition, by assigning the same reference numerals to components having the same configuration as those in the optical device 1C according to the fourth embodiment, overlapped descriptions of the configuration and the operation thereof will be omitted. The optical device 1D according to the fifth embodiment is different from the optical device 1C according to the fourth embodiment in that the terminal end of each of the second straight line waveguides 3B that are included in the second waveguide 3 and that are located at the end point X3 (Y2) of an adiabatic conversion unit 5D is made gradually away from the third waveguide 4.

Each of the second waveguides 3 includes the two first straight line waveguides 3A, the two second straight line waveguides 3B, and two bent waveguides 3C. Each of the bent waveguides 3C is a waveguide that is bent from the start point X3 toward the end point so as to be gradually away from the third waveguide 4.

A line connecting between the core center of each of the first tapered waveguides 2A2 at the associated start point X1 and the core center of each of the first tapered waveguides 2A2 at the associated end point X2 is denoted by the first center line CL1. A line connecting between the core center of each of the second tapered waveguides 2B2 at the associated start point X2 and the core center of each of the second tapered waveguides 2B2 at the associated end point X3 is denoted by the third center line CL3.

A distance between the core center at the end point X2 of one of the first tapered waveguides 2A2 and the core center at the end point X2 of the other of the first tapered waveguides 2A2 is denoted by the second space L2A. A distance between the core center at the end point X3 of one of the second tapered waveguides 2B2 and the core center at the end point X3 of the other of the second tapered waveguides 2B2 is denoted by the third space L3A. Then, the relationship among the first space L1, the second space L2A, and the third space L3A is represented by L1>L2A, L1>L3A, and L2A>L3A.

The optical device 1D is constituted to have a structure such that the distance between the two first tapered waveguides 2A2 is set to be the first space L1 in order to widen a portion of the first waveguide 2 that is located at the chip end surface D1 and that is optically coupled to the core of the optical fiber, and in order to bring the mode field of the optical device 1D closer to the core of the optical fiber. Consequently, as a result of the mode field of the optical device 1D at the chip end surface D1 being closer to the mode field of the core of the optical fiber, the coupling efficiency of the optical device 1D with the core of the optical fiber is improved.

In the adiabatic conversion unit 5D, each of the two second tapered waveguides 2B2 is constituted to have a structure such that the third space L3A is made narrower than the second space L2A. As a result, the mode field of the adiabatic conversion unit 5D is closer to the mode field of the straight line waveguide 4B included in the third waveguide 4, so that it is possible to suppress a coupling loss with the third waveguide 4 occurring in the adiabatic conversion unit 5D.

The adiabatic conversion unit 5D includes the two second tapered waveguides 2B2 that are included in the first waveguide 2, and the third tapered waveguide 4A2 that is included in the third waveguide 4. The adiabatic conversion unit 5D is constituted by arranging the third tapered waveguide 4A2, between the two second tapered waveguides 2B2, below the second tapered waveguides 2B2 side by side with the second tapered waveguides 2B2 in a state in which the third tapered waveguide 4A2 is separated from the second tapered waveguides 2B2. In addition, the space between each of the second tapered waveguides 2B2 and the third tapered waveguide 4A2 is set to be the same. Furthermore, each of the bent waveguides 3C that is connected to the end point X3 of the associated second straight line waveguide 3B is constituted such that the terminal end of each of the second straight line waveguides 3B is gradually away from the straight line waveguide 4B that is included in the third waveguide 4.

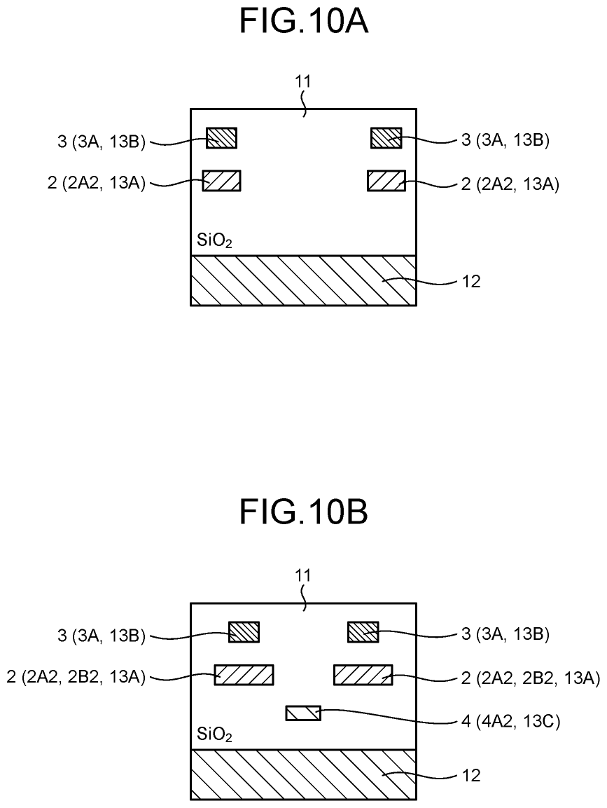

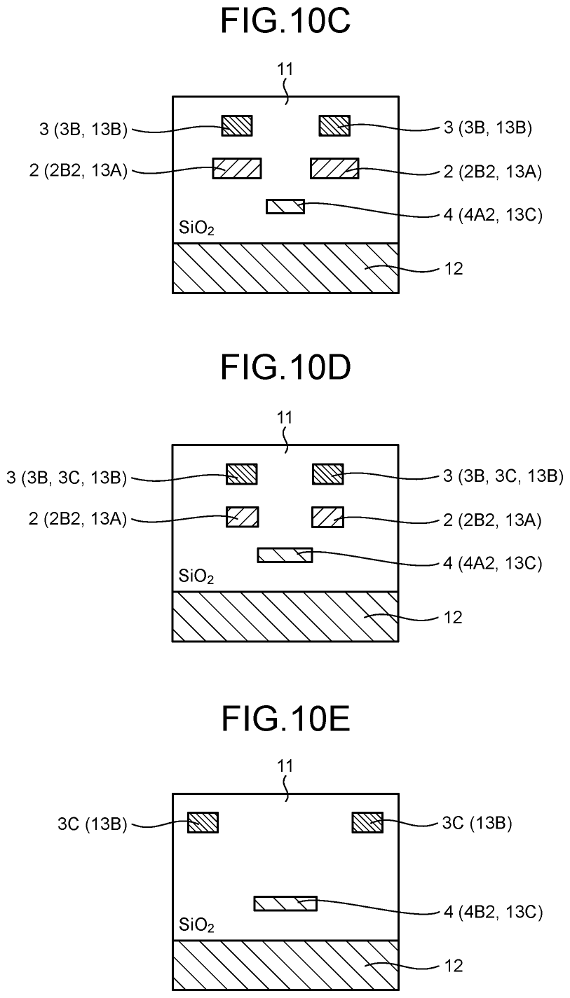

The adiabatic conversion unit 5D includes the start point X2 (Y1), the end point X3 (Y2), and an intermediate portion that is located between the start point X2 (Y1) and the end point X3 (Y2). FIG. 10A is a diagram illustrating one example of a schematic cross-sectional portion taken along line A-A illustrated in FIG. 9. The schematic cross-sectional portion taken along the line A-A illustrated in FIG. 10A is a cross-sectional part of the optical device 1D in which the two first tapered waveguides 2A2 included in the first waveguide 2 is arranged. The optical device 1D includes the clad 11, the Si substrate 12, the first assembly layers 13A, the second assembly layer 13B, and the third assembly layer 13C. In each of the first assembly layers 13A, the associated first tapered waveguide 2A2 included in the first waveguide 2 is arranged. In each of the second assembly layer 13B, the associated first straight line waveguide 3A included in the second waveguide 3 is arranged.

FIG. 10B is a diagram illustrating one example of a schematic cross-sectional portion taken along line B-B illustrated in FIG. 9. The schematic cross-sectional portion taken along the line B-B illustrated in FIG. 10B is a cross-sectional part of the optical device 1D in which the start point of the adiabatic conversion unit 5D is arranged. The optical device 1D includes the clad 11, the Si substrate 12, the first assembly layers 13A, the second assembly layers 13B, and the third assembly layer 13C. In each of the first assembly layers 13A, a connection portion between each of the first tapered waveguides 2A2 and the associated second tapered waveguide 2B2 that are included in the first waveguide 2. In each of the second assembly layers 13B, the associated first straight line waveguide 3A included in the second waveguide 3 is arranged. In the third assembly layer 13C, the third tapered waveguide 4A2 included in the third waveguide 4 is arranged. The adiabatic conversion unit 5D has a structure in which the third tapered waveguide 4A2 is disposed, between the two second tapered waveguides 2B2, side by side with the two second tapered waveguides 2B2.

FIG. 10C is a diagram illustrating one example of a schematic cross-sectional portion taken along line C-C illustrated in FIG. 9. The schematic cross-sectional portion taken along the line C-C illustrated in FIG. 10C is a cross-sectional part of the optical device 1D in which an intermediate point of the adiabatic conversion unit 5D is arranged. The optical device 1D includes the clad 11, the Si substrate 12, the first assembly layers 13A, the second assembly layers 13B, and the third assembly layer 13C. In each of the first assembly layers 13A, the associated second tapered waveguide 2B2 included in the first waveguide 2 is arranged. In each of the second assembly layers 13B, the associated second straight line waveguide 3B included in the second waveguide 3 is arranged. In the third assembly layer 13C, the third tapered waveguide 4A2 included in the third waveguide 4 is arranged.

FIG. 10D is a diagram illustrating one example of a schematic cross-sectional portion taken along line D-D illustrated in FIG. 9. The schematic cross-sectional portion taken along the line D-D illustrated in FIG. 10D is a cross-sectional part of the optical device 1D in which the end point of the adiabatic conversion unit 5D is arranged. The optical device 1D includes the clad 11, the Si substrate 12, the first assembly layers 13A, the second assembly layers 13B, and the third assembly layer 13C. In each of the first assembly layer 13A, the associated second tapered waveguide 2B2 included in the first waveguide 2 is arranged. In each of the second assembly layer 13B, a joining portion between the second straight line waveguide 3B and the bent waveguide 3C that are included in the second waveguide 3 is arranged. In the third assembly layer 13C, the third tapered waveguide 4A2 included in the third waveguide 4 is arranged.

FIG. 10E is a diagram illustrating one example of a schematic cross-sectional portion taken along line E-E illustrated in FIG. 9. The schematic cross-sectional portion taken along the line E-E illustrated in FIG. 10E is a cross-sectional part of the optical device 1D in which each of the bent waveguides 3C included in the second waveguide 3 and the straight line waveguide 4B2 included in the third waveguide 4 are arranged. The optical device 1D includes the clad 11, the Si substrate 12, the first assembly layers 13A, the second assembly layer s13B, and the third assembly layer 13C. In each of the second assembly layers 13B, the associated bent waveguide 3C included in the second waveguide 3 is arranged. In the third assembly layer 13C, the straight line waveguide 4B2 included in the third waveguide 4 is arranged.

The start point of the adiabatic conversion unit 5D is a portion in which the start point X2 of each of the second tapered waveguides 2B2 and the start point Y1 of the third tapered waveguide 4A2 are arranged. The waveguide width of the start point X2 of each of the second tapered waveguides 2B2 is made wider than the waveguide width of the start point Y1 of the third tapered waveguide 4A2. The adiabatic conversion unit 5D has a structure in which the third tapered waveguide 4A2 is disposed, between the two second tapered waveguides 2B2, side by side with the second tapered waveguides 2B2 at a position below the second tapered waveguides 2B2. The end point of the adiabatic conversion unit 5D is a portion in which the end points X3 of the respective second tapered waveguides 2B2 and the end point Y2 of the third tapered waveguide 4A2 are arranged.

In the optical device 1D according to the fifth embodiment, each of the bent waveguides 3C is connected at the end point X3 of the associated second straight line waveguide 3B included in the adiabatic conversion unit 5D such that each of the bent waveguides 3C is gradually away from the straight line waveguide 4B2 of the third waveguide 4. Consequently, the terminal end of the second waveguide 3 is gradually away from the third waveguide 4 at the end point of the adiabatic conversion unit 5D, so that it is possible to suppress a scattering loss of light as a result of the refractive index distribution of light being slowly changed.

In addition, in the optical device 1 according to the first to the fifth embodiments, although the coupling efficiency with a fiber having a large mode field diameter is improved; however, a leakage of light from the second waveguide 3 generates a propagation loss. Accordingly, a separation area may be provided by forming a trench around the first waveguide 2, the second waveguide 3, and the third waveguide 4, and an embodiment thereof will be described as an optical device 1E according to a sixth embodiment.

### (f) Sixth Embodiment

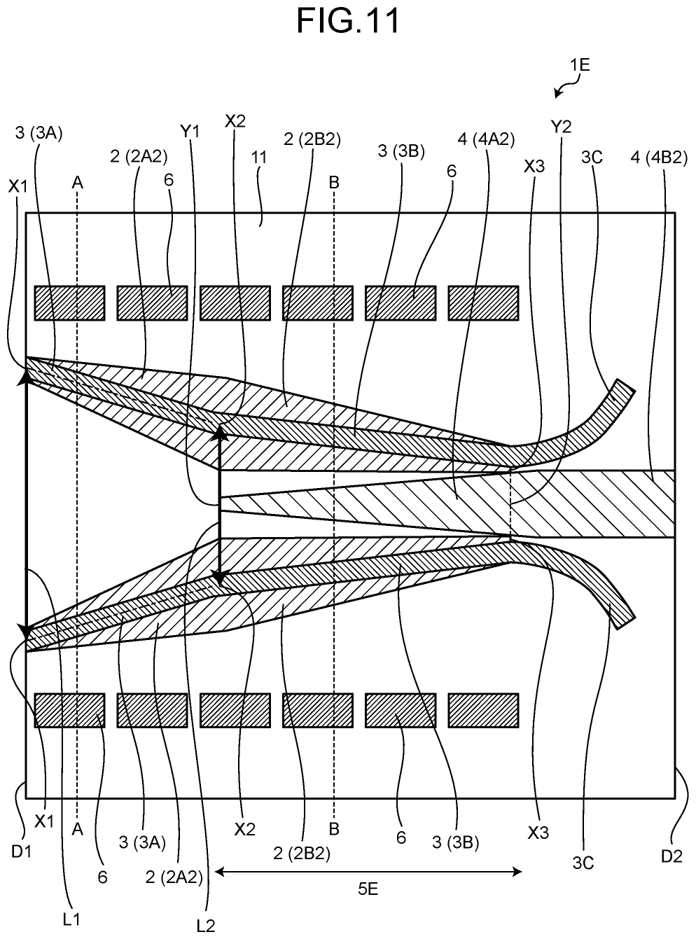

FIG. 11 is a diagram illustrating one example of the optical device 1E according to the sixth embodiment. The optical device 1E according to the sixth embodiment is different from the optical device 1D according to the fifth embodiment in that a plurality of separation areas 6A are formed by forming a plurality of trenches 6 in the interior of the clad 11 that is located around the outside of the first waveguide 2 and the second waveguide 3.

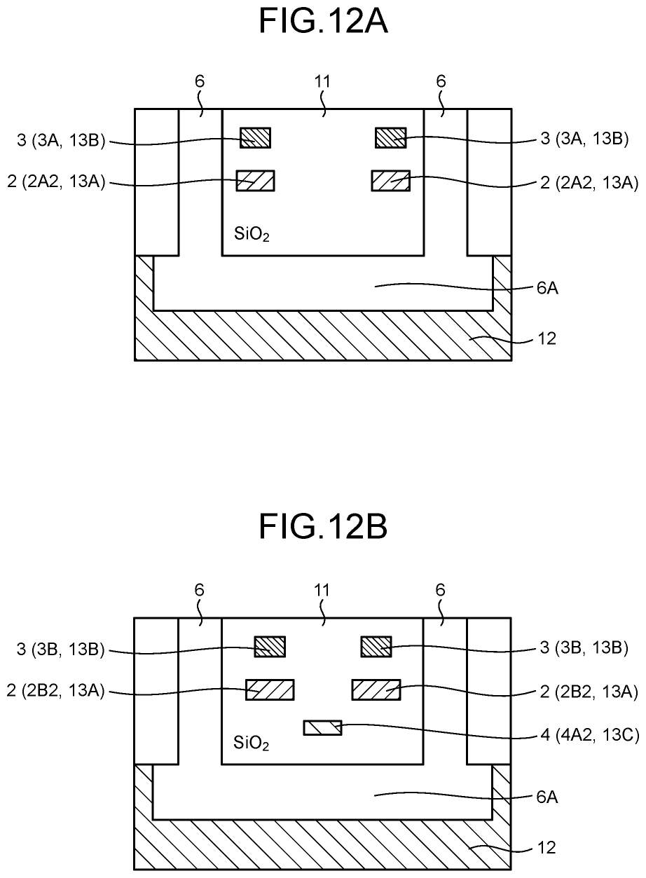

FIG. 12A is a diagram illustrating one example of a schematic cross-sectional portion taken along line A-A illustrated in FIG. 11. The cross-sectional portion of the optical device 1E illustrated in FIG. 12A taken along the line A-A is a cross-sectional part of the optical device 1E in which the first tapered waveguides 2A2 included in the first waveguide 2 are arranged. The optical device 1E illustrated in FIG. 12A includes the clad 11, the Si substrate 12, the first assembly layers 13A, the second assembly layers 13B, the third assembly layer 13C, the trenches 6, and the separation areas 6A. In each of the first assembly layers 13A, the associated first tapered waveguide 2A2 included in the first waveguide 2 is arranged. In each of the second assembly layers 13B, the associated first straight line waveguide 3A included in the second waveguide 3 is arranged. The separation area 6A is a layer that separates a portion between the Si substrate 12 and clad 11.

FIG. 12B is a diagram illustrating one example of a schematic cross-sectional portion taken along line B-B illustrated in FIG. 11. FIG. 12B is a diagram illustrating one example of the schematic cross-sectional portion taken along the line B-B illustrated in FIG. 11. The schematic cross-sectional portion taken along the line B-B illustrated in FIG. 12B is a cross-sectional part of the optical device 1E in which an adiabatic conversion unit 5E is arranged. The optical device 1E includes the clad 11, the Si substrate 12, the first assembly layers 13A, the second assembly layers 13B, the third assembly layer 13C, the trenches 6, and the separation areas 6A. In each of the first assembly layers 13A, the associated second tapered waveguide 2B2 included in the first waveguide 2 is arranged. In each of the second assembly layers 13B, the associated second straight line waveguide 3B included in the second waveguide 3 is arranged. In the third assembly layer 13C, the third tapered waveguide 4A2 included in the third waveguide 4 is arranged.

In the optical device 1E according to the sixth embodiment, the separation areas 6A and the trenches 6 are formed in the clad 11 that is located around the adiabatic conversion unit 5E, so that it is possible to suppress a propagation loss caused by a leakage of light from the second waveguide 3.

In addition, a case has been described as an example in which the optical device 1E according to the sixth embodiment has a structure in which the separation areas 6A are formed by the trenches 6; however, a refractive index difference between the clad 11 and the separation area 6A is large, so that a scattering loss of light caused by roughness of the surface occurs. Accordingly, in order to cope with the circumstances, a resin may be filled in the separation areas 6A, and an embodiment of an optical device 1F will be described as a seventh embodiment.

### (g) Seventh Embodiment

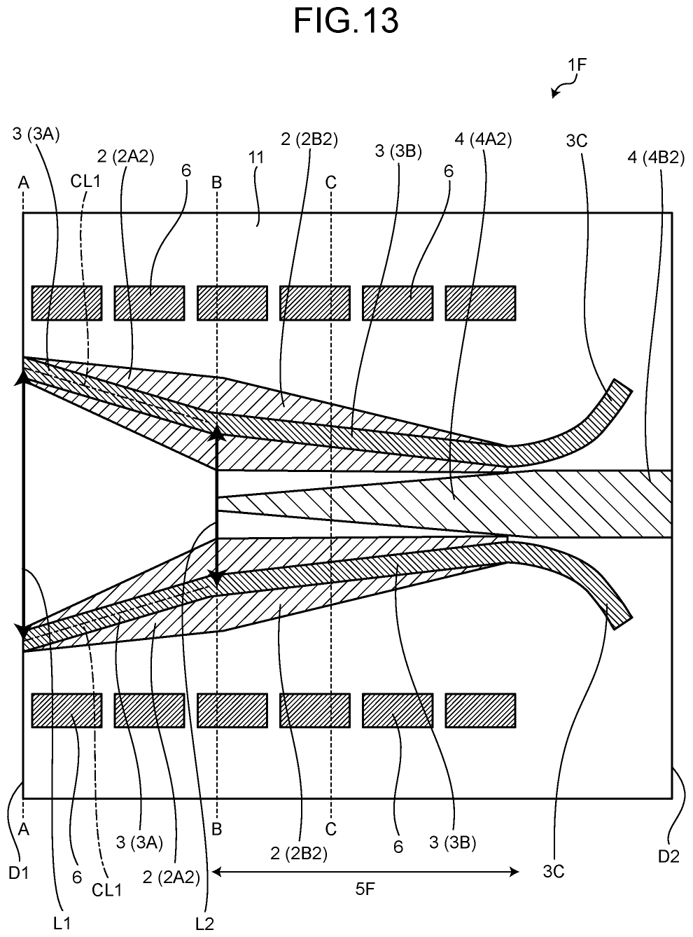

FIG. 13 is a diagram illustrating one example of the optical device 1F according to the seventh embodiment. In addition, by assigning the same reference numerals to components having the same configuration as those in the optical device 1E according to the sixth embodiment, overlapped descriptions of the configuration and the operation thereof will be omitted. The optical device 1F according to the seventh embodiment is different from the optical device 1E according to the sixth embodiment in that a filling layer 7 is provided by filling a resin or an adhesive agent in the separation areas 6A and the trenches 6. The resin or the adhesive agent is a material having a refractive index that is larger than that of air.

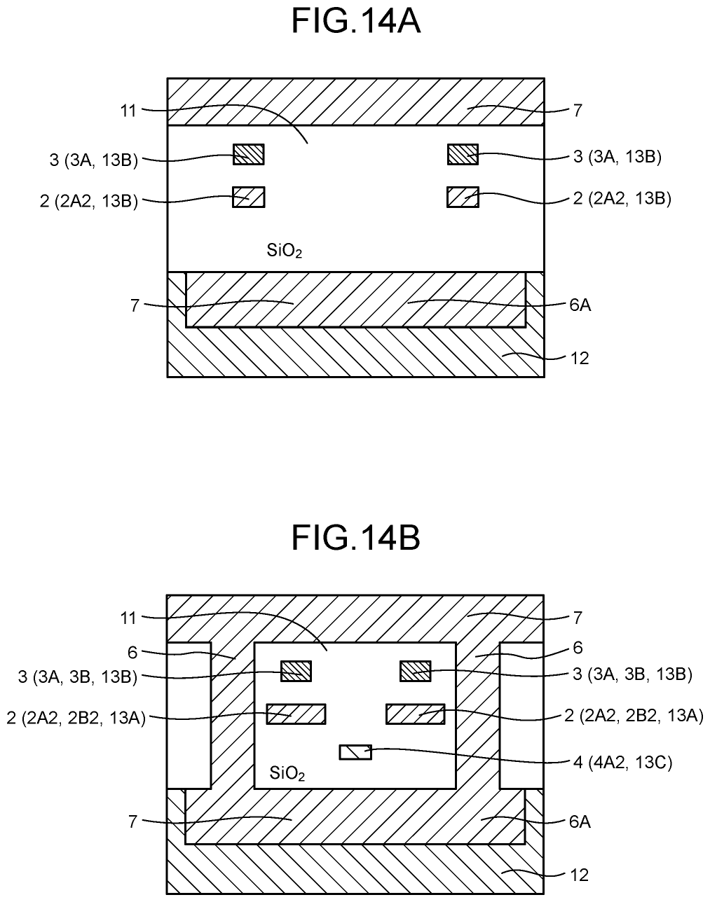

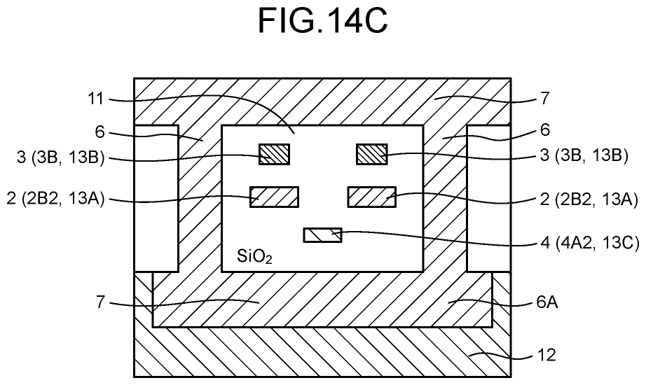

FIG. 14A is a diagram of one example of a schematic cross-sectional portion taken along line A-A illustrated in FIG. 13. The cross-sectional portion of the optical device 1F illustrated in FIG. 14A taken along the line A-A is a cross-sectional part of the optical device 1E in which each of the first tapered waveguides 2A2 included in the first waveguide 2 is arranged. The optical device 1F illustrated in FIG. 14A includes the clad 11, the Si substrate 12, the first assembly layers 13A, the second assembly layers 13B, the third assembly layer 13C, and the filling layer 7. In each of the first assembly layers 13A, the associated first tapered waveguide 2A2 included in the first waveguide 2 is arranged. In each of the second assembly layers 13B, the associated first straight line waveguide 3A included in the second waveguide 3 is arranged.

FIG. 14B is a diagram illustrating one example of a schematic cross-sectional portion taken along line B-B illustrated in FIG. 13. The schematic cross-sectional portion taken along the line B-B illustrated in FIG. 14B is a cross-sectional part of the optical device 1F in which an adiabatic conversion unit 5F is arranged. The optical device 1F includes the clad 11, the Si substrate 12, the first assembly layers 13A, the second assembly layers 13B, the third assembly layer 13C, and the filling layer 7. In each of the first assembly layers 13A, a joining portion between the first tapered waveguide 2A2 included and the second tapered waveguide 2B2 that are in the first waveguide 2 is arranged. In each of the second assembly layers 13B, joining portion between the first straight line waveguide 3A and the second straight line waveguide 3B that are included in the second waveguide 3 is arranged. In the third assembly layer 13C, the third tapered waveguide 4A2 included in the third waveguide 4 is arranged.

FIG. 14C is a diagram illustrating one example of a schematic cross-sectional portion taken along line C-C illustrated in FIG. 13. The schematic cross-sectional portion taken along the line C-C illustrated in FIG. 14C is a cross-sectional part of the optical device 1F in which the adiabatic conversion unit 5F is arranged. The optical device 1F includes the clad 11, the Si substrate 12, the first assembly layers 13A, the second assembly layers 13B, the third assembly layer 13C, and the filling layer 7. In each of the first assembly layers 13A, the associated second tapered waveguide 2B2 included in the first waveguide 2 is arranged. In each of the second assembly layers 13B, the associated second straight line waveguide 3B included in the second waveguide 3 is arranged. In the third assembly layer 13C, the third tapered waveguide 4A2 included in the third waveguide 4 is arranged.

In the optical device 1F according to the seventh embodiment, the filling layer 7 is formed by filling a resin, an adhesive agent, or the like in each of the separation areas 6A and in the interior of each of the trenches 6 that are formed at the clad 11 located around the first waveguide 2 and the second waveguide 3, so that it is possible suppress a scattering loss of light.

In addition, a case has been described as an example in which, in the optical device 1F according to the seventh embodiment, the first waveguide 2 is arranged in the first assembly layer 13A. However, the example is not limited to this, but the first waveguide 2 may be arranged in the third assembly layer 13C, and an embodiment of an optical device 1G will be described as an eighth embodiment.

### (h) Eighth Embodiment

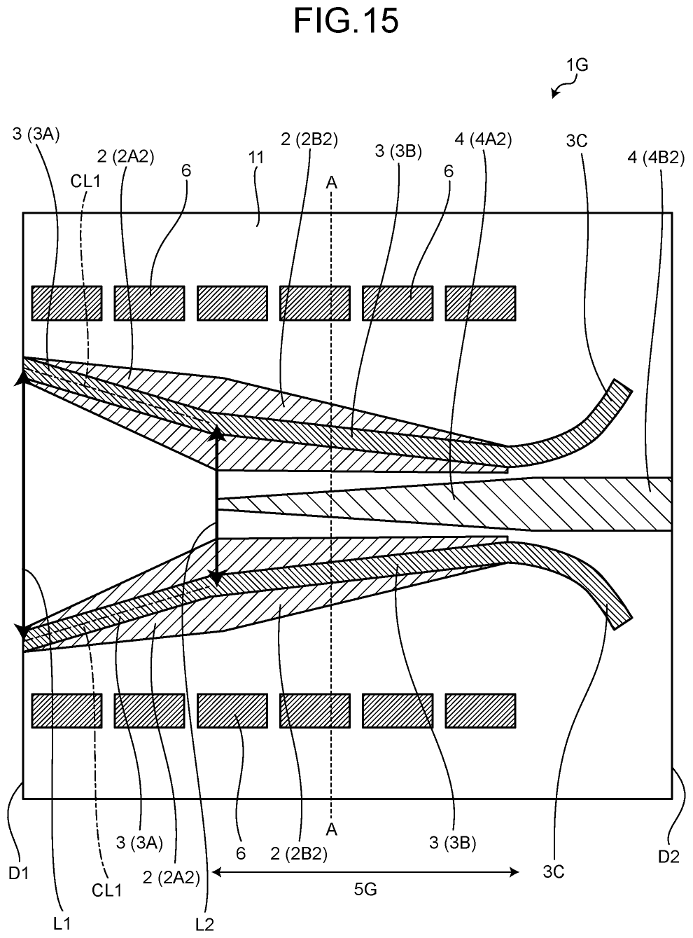

FIG. 15 is a diagram illustrating one example of the optical device 1G according to the eighth embodiment. In addition, by assigning the same reference numerals to components having the same configuration as those in the optical device 1F according to the seventh embodiment, overlapped descriptions of the configuration and the operation thereof will be omitted. The optical device 1G according to the eighth embodiment is different from the optical device 1F according to the seventh embodiment in that the first waveguide 2 and the third waveguide 4 are arranged in the third assembly layer 13C.

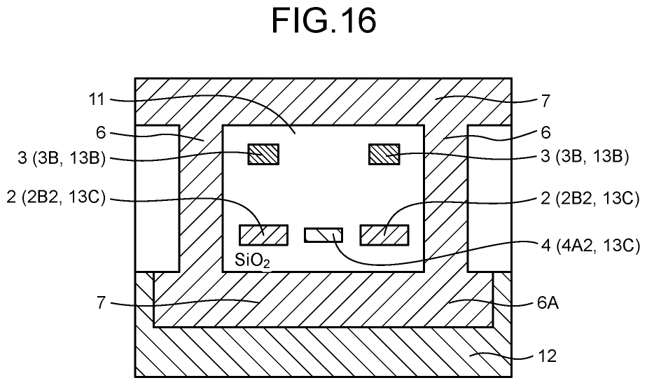

FIG. 16 is a diagram illustrating one example of a schematic cross-sectional portion taken along line A-A illustrated in FIG. 15. The cross-sectional portion of the optical device 1G illustrated in FIG. 16 taken along the line A-A is a cross-sectional part of the optical device 1E in which each of the first tapered waveguides 2A2 included in the first waveguide 2 is arranged. The optical device 1G illustrated in FIG. 16 includes the clad 11, the Si substrate 12, the first assembly layer 13A, the second assembly layers 13B, the third assembly layers 13C, and the filling layer 7. In the third assembly layers 13C, the second tapered waveguide 2B2 included in the first waveguide 2 and the third tapered waveguide 4A2 included in and the third waveguide 4 are arranged. In each of the second assembly layer 13B, the associated second straight line waveguide 3B included in the second waveguide 3 is arranged.

In the optical device 1G according to the eighth embodiment, the first waveguide 2 and the third waveguide 4 are arranged in the third assembly layers 13C, the mode field of an adiabatic conversion unit 5G at the end point is made large, and thus, it is possible to further improve the coupling efficiency between the first waveguide 2 and the third waveguide 4.

In addition, the structure is not limited to the optical device 1 according to the first embodiment, but a fourth waveguide 8 may be arranged above the third tapered waveguide 4A included in the third waveguide 4, and an embodiment of an optical device 1H will be described as a ninth embodiment.

### (i) Ninth Embodiment

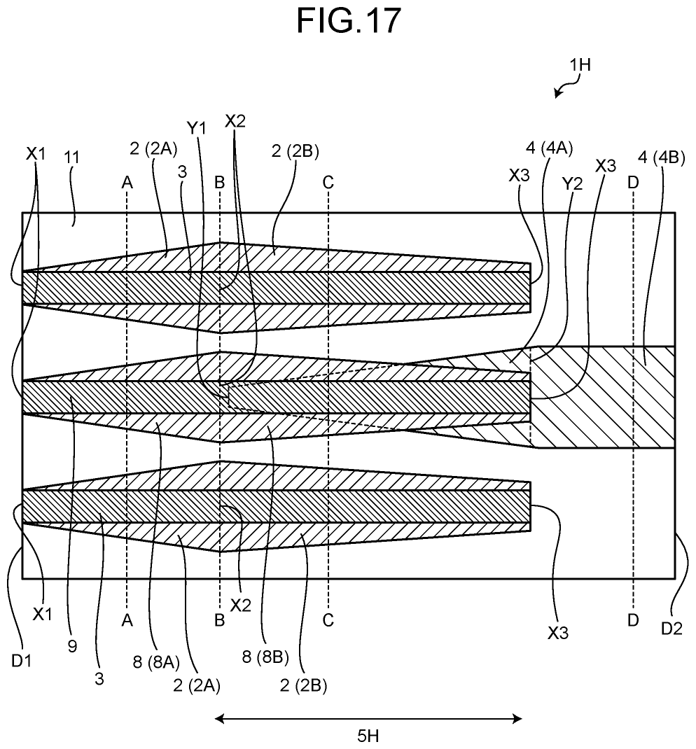

FIG. 17 is a diagram illustrating one example of the optical device 1H according to the ninth embodiment. In addition, by assigning the same reference numerals to components having the same configuration as those in the optical device 1 according to the first embodiment, overlapped descriptions of the configuration and the operation thereof will be omitted. The optical device 1H according to the ninth embodiment is different from the optical device 1 according to the first embodiment in that the fourth waveguide 8 is arranged above the third tapered waveguide 4A included in the third waveguide 4.

The fourth waveguide 8 is for example, a SiN waveguide that includes a fifth tapered waveguide 8A and a sixth tapered waveguide 8B. The fourth waveguide 8 has a structure in which the material refractive index of SiN is 1.99 in the case where, for example, the optical wavelength is 1.55 μm. The fifth tapered waveguide 8A is a waveguide that has a structure in which the waveguide width is gradually wider from the start point X1 toward the end point X2. The sixth tapered waveguide 8B is a waveguide that has a structure in which the waveguide width is gradually narrower from the start point X2 toward the end point X3. By connecting the end point X2 of the fifth tapered waveguide 8A and the start point X2 of the sixth tapered waveguide 8B, a portion between the fifth tapered waveguide 8A and the sixth tapered waveguide 8B is connected. The thickness of the core of the fifth tapered waveguide 8A is set to be the same as that of the sixth tapered waveguide 8B. The start point X1 of the fourth waveguide 8 starts at the chip end surface D1 of the optical device 1H that is optically coupled to the core of the optical fiber.

A fifth waveguide 9 is a straight line waveguide that is arranged above the fourth waveguide 8. In the fifth waveguide 9, the material refractive index of SiN is 1.99 in the case where, for example, the optical wavelength is 1.55 μm.

An adiabatic conversion unit 5H is constituted such that the third tapered waveguide 4A is arranged between the two second tapered waveguides 2B, below the sixth tapered waveguide 8B included in the fourth waveguide 8 in a state in which the third tapered waveguide 4A is separated from the two second tapered waveguides 2B. In addition, in the first waveguide 2 and the fourth waveguide 8, the mode field is present across a portion that is located mainly around the two second tapered waveguides 2B and the sixth tapered waveguide 8B, so that light is adiabatically transitioned from the first waveguide 2 and the fourth waveguide 8 toward the third waveguide 4.

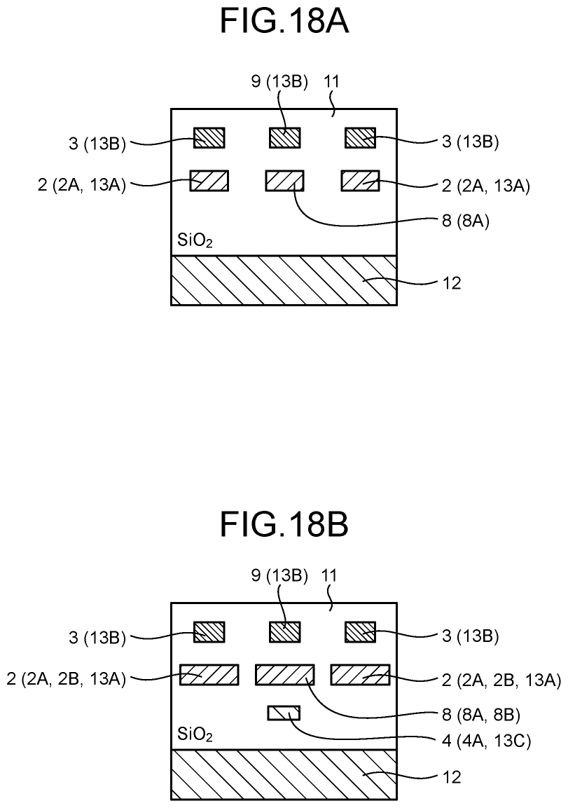

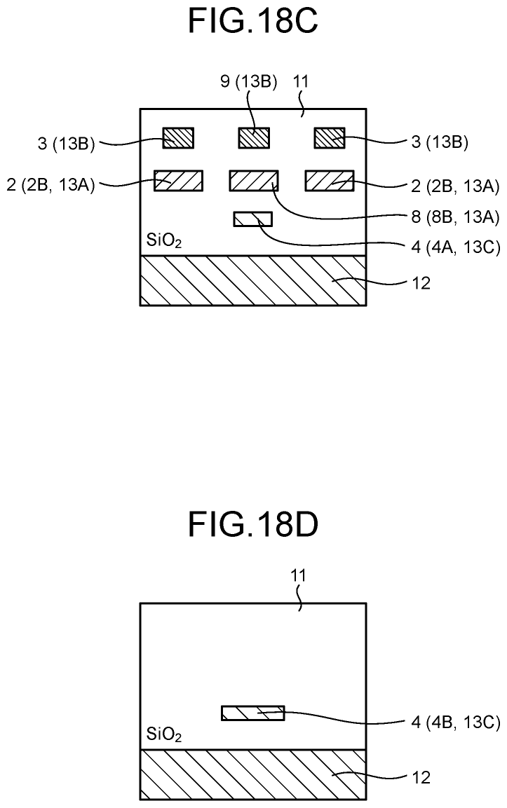

The adiabatic conversion unit 5H includes the start point X2 (Y1), the end point X3 (Y2), and an intermediate portion that is located between the start point X2 (Y1) and the end point X3 (Y2). FIG. 18A is a diagram illustrating one example of a schematic cross-sectional portion taken along line A-A illustrated in FIG. 17. The schematic cross-sectional portion taken along the line A-A illustrated in FIG. 18A is a cross-sectional part of the optical device 1H in which the two first tapered waveguides 2A that are included in the first waveguide 2 and a single piece of the fifth tapered waveguide 8A that is included in the fourth waveguide 8 are arranged. The optical device 1H includes the clad 11, the Si substrate 12, the first assembly layers 13A, the second assembly layers 13B, and the third assembly layers 13C. In one of the first assembly layers 13A, the fifth tapered waveguide 8A included in the fourth waveguide 8 is arranged, and, in each of the other of the first assembly layers 13A, the first tapered waveguide 2A included in the first waveguide 2 is arranged. In each of the second assembly layers 13B, the associated second waveguide 3 and the fifth waveguide 9 are arranged.

FIG. 18B is a diagram illustrating one example of a schematic cross-sectional portion taken along line B-B illustrated in FIG. 17. The schematic cross-sectional portion taken along the line B-B illustrated in FIG. 18B is a cross-sectional part of the optical device 1H in which the start point of the adiabatic conversion unit 5H is arranged. The optical device 1H includes the clad 11, the Si substrate 12, the first assembly layers 13A, the second assembly layers 13B, and the third assembly layers 13C. In each of the first assembly layers 13A, a connection portion between the first tapered waveguide 2A and the second tapered waveguide 2B that are included in the first waveguide 2 is arranged. In the first assembly layer 13A, a connection portion between the fifth tapered waveguide 8A and the sixth tapered waveguide 8B that are included in the fourth waveguide 8 is arranged.

In the second assembly layers 13B, the second waveguides 3 and the fifth waveguide 9 are arranged. In the third assembly layer 13C, the third tapered waveguide 4A included in the third waveguide 4 is arranged. The adiabatic conversion unit 5H has a structure in which the third tapered waveguide 4A is disposed, between the two second tapered waveguides 2B, side by side with the second tapered waveguides 2B at a position above the single piece of the sixth tapered waveguide 8B.

FIG. 18C is a diagram illustrating one example of a schematic cross-sectional portion taken along line C-C illustrated in FIG. 17. The schematic cross-sectional portion taken along the line C-C illustrated in FIG. 18C is a cross-sectional part of the optical device 1H in which an intermediate point of the adiabatic conversion unit 5H is arranged. The optical device 1H includes the clad 11, the Si substrate 12, the first assembly layers 13A, the second assembly layers 13B, and the third assembly layer 13C. In the first assembly layers 13A, the second tapered waveguides 2B included in the first waveguide 2 and the sixth tapered waveguide 8B included in the fourth waveguide 8 are arranged. In the second assembly layer 13B, the second waveguides 3 and the fifth waveguide 9 are arranged. In the third assembly layer 13C, the third tapered waveguide 4A included in the third waveguide 4 is arranged.

FIG. 18D is a diagram illustrating one example of a schematic cross-sectional portion taken along line D-D illustrated in FIG. 17. The schematic cross-sectional portion taken along the line D-D illustrated in FIG. 18D is a cross-sectional part of the optical device 1 in which the straight line waveguide 4B included in the third waveguide 4 is arranged. The optical device 1 includes the clad 11, the Si substrate 12, the first assembly layers 13A, the second assembly layers 13B, and the third assembly layer 13C. In the third assembly layer 13C, the straight line waveguide 4B included in the third waveguide 4 is arranged.

In the optical device 1H according to the ninth embodiment, the waveguide width of each of the two first tapered waveguides 2A that are included in the first waveguide 2 and the waveguide width of the single piece of the fifth tapered waveguide 8A that is included in the fourth waveguide 8 are made gradually wide, it is possible to strongly confine light. As a result, a radiation loss occurring at the leading end of the third waveguide 4 located at the start point of the adiabatic conversion unit 5H is decreased, so that it is possible to shorten the length of the adiabatic conversion unit 5H.

In the adiabatic conversion unit 5H, the third tapered waveguide 4A is arranged between the two second tapered waveguides 2B (the second waveguides 3) and above the sixth tapered waveguide 8B (the fifth waveguide 9). Then, light is adiabatically transitioned from the second tapered waveguide 2B (the second waveguide 3) and the sixth tapered waveguide 8B (the fifth waveguide 9) to the third tapered waveguide 4A. As a result, a discontinuous portion is not present in the interior of the first waveguide 2 and the fourth waveguide 8, so that it is possible to suppress an occurrence of a radiation loss and a reflection loss of light.

In the optical device 1H, the two first waveguides 2 and the fourth waveguide 8 are arranged in the first assembly layers 13A, and the two second waveguides 3 and the fifth waveguide 9 are arranged in the second assembly layer 13B on the chip end surface D1 side. As a result, it is possible to suppress a coupling loss with the optical fiber to some extent by bringing the mode field of each of the first waveguide 2, the fourth waveguide 8, the second waveguide 3, and the fifth waveguide 9 closer to the mode field of the optical fiber.

In other words, in the optical device 1H, it is possible to suppress a radiation loss and a reflection loss in a section to the adiabatic conversion unit 5H while reducing a coupling loss with the fiber at the chip end surface.

In addition, in the embodiment, the second tapered waveguide 2B and the third tapered waveguide 4A included in the adiabatic conversion unit 5 may be a Planar Lightwave Circuit (PLC) in which both of the core and the clad are made of SiO₂, or may be an InP waveguide or a GaAs waveguide. The core may be made of Si or Si₃N₄, a lower part clad may be made of SiO₂, and an upper part clad may be made of SiO₂ or may be air or the like. In addition, this may be applicable in the case where the material refractive index of the waveguide provided at the transition destination is higher than the material refractive index of the waveguide provided at the transition source. For example, in a case of the PLC, it is also applicable by changing the material refractive index at the transition source and the transition destination by changing an amount of doping into a glass waveguide.

In addition, the SiN waveguide has been exemplified as the first waveguide 2, the Si waveguide has been exemplified as the third waveguide 4, and SiO₂ has been exemplified as the clad 11. However, the materials of the first waveguide 2, the third waveguide 4, and the clad 11 may appropriately be changed as long as the refractive index of the material of the clad 11 is set to be smaller than the refractive index of the material of the first waveguide 2, and the refractive index of the material of the first waveguide 2 is set to be smaller than the refractive index of the material of the third waveguide 4.

In the case of the PLC, it is possible to change the material refractive index by changing an amount of doping into the core. In the case of the first waveguide 2 and the third waveguide 4, the relative refractive index difference is large, so that light is strongly confined, and, as a result, it is possible to implement a bent waveguide having a low loss even if a radius R is small, and it is thus possible to reduce the size of the optical device 1.

The structure of each of the first waveguide 2 and the third waveguide 4 may be a rib waveguide, a ridge waveguide, or a channel waveguide, and appropriate modifications are possible. If the structure of each of the first waveguide 2 and the third waveguide 4 is a rib waveguide, light is also leaked to a slab portion, the effect of the rough side walls of the core is small, and it is thus possible to suppress an optical loss. If the structure of each of the first waveguide 2 and the third waveguide 4 is a channel waveguide, confinement of light is strong, so that it is possible to sharply bend the waveguide, and it is thus possible to reduce the size of the optical device 1. The clad 11 may be made of an arbitrary material as long as the material refractive index is smaller than that of the core, and appropriate modifications are possible.

A case has been described as an example in which the optical device 1 (1A to 1H) according to the present embodiment is a silicon optical waveguide formed by using Si as the material of the third waveguide 4 and by using SiO₂ as the material of the clad 11. However, it is also applicable to a PLC, an InP waveguide, and a GaAs waveguide in which the material of each of the third waveguide 4 and the clad 11 is SiO₂.

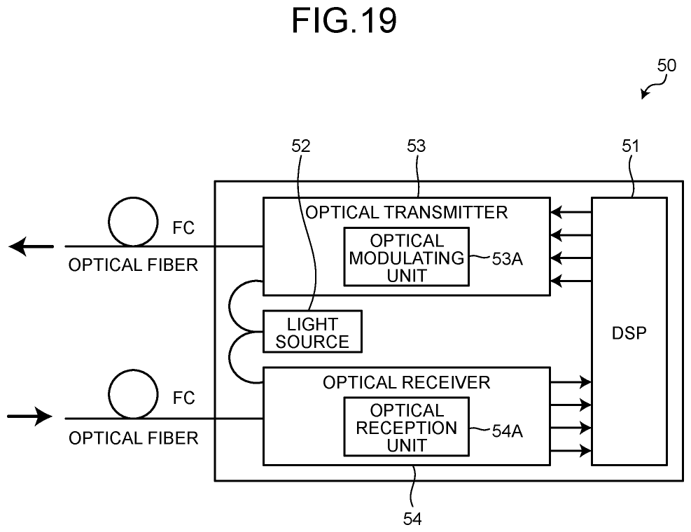

FIG. 19 is a diagram illustrating one example of an optical communication apparatus that includes the optical device 1 as a built-in unit. An optical communication apparatus 50 illustrated in FIG. 19 is connected to an optical fiber disposed on an output side and an optical fiber disposed on an input side. The optical communication apparatus 50 includes a digital signal processor (DSP) 51, a light source 52, an optical transmitter 53, and an optical receiver 54. The DSP 51 is an electrical component that performs digital signal processing. The DSP 51 performs a process of, for example, encoding transmission data or the like, generating an electrical signal including transmission data, and outputs the generated electrical signal to the optical transmitter 53. Furthermore, the DSP 51 acquires an electrical signal including reception data from the optical receiver 54 and obtains reception data by performing a process of, for example, decoding the acquired electrical signal.

The light source 52 includes, for example, a laser diode or the like, generates light with a predetermined wavelength, and supplies the generated light to the optical transmitter 53 and the optical receiver 54. The optical transmitter 53 modulates, by using the electrical signal output from the DSP 51, the light supplied from the light source 52, and outputs the obtained transmission light to the optical fiber. The optical transmitter 53 includes an optical modulating unit 53A that generates the transmission light by modulating, when the light supplied from the light source 52 propagates through the waveguide, the light by using the electrical signal that is input to the optical modulator.

The optical receiver 54 includes an optical reception unit 54A that receives the optical signal from the optical fiber and demodulates the received light by using the light that is supplied from the light source 52. Then, the optical receiver 54 converts the demodulated received light to an electrical signal and outputs the converted electrical signal to the DSP 51. In the optical transmitter 53 and the optical receiver 54, the optical device 1 corresponding to the substrate type optical waveguide element functioning as a waveguide through which light is propagated is installed as a built in device.

In the adiabatic conversion unit 5 (5A to 5H) included in the optical device 1 (1A to 1H) in the optical communication apparatus 50, the mode field of the optical device 1 at the chip end surface D1 is closer to the mode field of the core of the optical fiber, so that it is possible to improve the coupling efficiency of the optical device 1 with the core of the optical fiber.

In addition, for convenience of description, a case has been described as an example in which the optical communication apparatus 50 includes the optical transmitter 53 and the optical receiver 54 as the built in units; however the optical communication apparatus 50 may include one of the optical transmitter 53 and the optical receiver 54 as the built in unit. For example, the optical device 1 (1A to 1H) may be applied to the optical communication apparatus 50 having the optical transmitter 53 built in, or the optical communication apparatus 50 having the optical receiver 54 built in, and appropriate modifications are possible.

Each of the components in the units illustrated in the drawings is not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions.

Furthermore, all or any part of various processing functions performed by each unit may also be executed by a central processing unit (CPU) (or, a microcomputer, such as a micro processing unit (MPU) or a micro controller unit (MCU)). In addition, all or any part of various processing functions may also be, of course, executed by programs analyzed and executed by the CPU (or the microcomputer, such as the MPU or the MCU), or executed by hardware by wired logic.

According to an aspect of an embodiment, it is possible to suppress a radiation loss and a reflection loss in a section to an adiabatic conversion unit while reducing a coupling loss with a fiber at a chip end surface.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a first assembly layer that is formed on a substrate on a side closer to the substrate; and
a second assembly layer that is formed on the substrate on a side away from the substrate; wherein the optical device further includes
two first waveguides that are arranged in a side by side manner in the first assembly layer;
two second waveguides that are arranged in a side by side manner in the second assembly layer; and
a single third waveguide that is arranged between the first waveguides and between the second waveguides, wherein
each of the first waveguides includes
a first tapered waveguide, and
a second tapered waveguide that is connected to the first tapered waveguide,
the third waveguide includes
a third tapered waveguide that is disposed side by side with the second tapered waveguides, and
a fourth waveguide that is connected to the third tapered waveguide on a side away from each of the first tapered waveguides,
each of the first tapered waveguides has a structure in which a waveguide width is gradually narrower to a start point of the first tapered waveguide as the first tapered waveguide is away from a joining point with the associated second tapered waveguide,
each of the second tapered waveguides has a structure in which a waveguide width is gradually narrower as the second tapered waveguide is away from a joining point with the associated first tapered waveguide, and
the third tapered waveguide has a structure in which a waveguide width is gradually wider as the third tapered waveguide is closer to a joining point with the fourth waveguide.

2. The optical device according to claim 1, further including a third assembly layer that is arranged between the first assembly layer and the substrate, wherein
the third waveguide is arranged in the third assembly layer.

3. The optical device according to claim 1, wherein
each of the first waveguides covered by a clad on the substrate is made of a material including Silicon Nitride (SiN),
each of the second waveguides covered by the clad on the substrate is made of a material including Silicon (Si), and
the clad is made of a material including SiO₂.

4. The optical device according to claim 1, wherein
a refractive index of a material of a clad that covers the first waveguides, the second waveguides, and the third waveguide is smaller than a refractive index of a material of each of the first waveguides and the second waveguides, and
the refractive index of the material of each of the first waveguides is smaller than a refractive index of a material of the third waveguide.

5. The optical device according to claim 2, wherein each of the second waveguides is a straight line waveguide and is arranged on the associated first waveguide.

6. The optical device according to claim 2, wherein each of the first waveguides has a structure constituted such that a first space between the two first tapered waveguides at the respective start points of the first tapered waveguides is made wider than a second space between the two first tapered waveguides at respective connection portions between the first tapered waveguides and between the second tapered waveguides.

7. The optical device according to claim 6, wherein each of the first waveguides has a structure constituted such that a third space between the two second tapered waveguides at respective end points of the second tapered waveguides is made narrower than the second space.

8. The optical device according to claim 2, wherein
each of the second waveguides includes a first straight line waveguide and a second straight line waveguide,
the first straight line waveguides are arranged on the respective first tapered waveguides, and
the second straight line waveguides are arranged on the respective second tapered waveguides.

9. The optical device according to claim 8, wherein each of the second waveguides includes a bent waveguide that is connected to an end point of each of the second straight line waveguides and that is gradually away from the fourth waveguide included in the third waveguide.

10. The optical device according to claim 1, further including:
a clad that is arranged on the substrate, and that covers the first waveguide, the second waveguide, and the third waveguide; and
a separation area that is formed on the substrate and around the clad and that separates the substrate and the clad.

11. The optical device according to claim 10, further including a resin layer that is filled in the separation area.

12. The optical device according to claim 11, further including a third assembly layer that is arranged between the first assembly layer and the substrate, wherein
the third waveguide is arranged in the third assembly layer.

13. The optical device according to claim 1, further including:
a fifth waveguide that is arranged, in the first assembly layer, between the two first waveguides that are arranged in a side by side manner; and
a sixth waveguide that is arranged, in the second assembly layer, between the two second waveguides that are arranged in a side by side manner, wherein
the fifth waveguide includes
a fourth tapered waveguide, and
a fifth tapered waveguide that is connected to the fourth tapered waveguide,
the fourth tapered waveguide has a structure in which a waveguide width is gradually narrower to a start point of the fourth tapered waveguide as the fourth tapered waveguide is away from a joining point with the fifth tapered waveguide, and
the fifth tapered waveguide has a structure, in which a waveguide width is gradually narrower as the fifth tapered waveguide is away from a joining point with the fourth tapered waveguide, and is arranged on the third waveguide.

14. An optical transmitter comprising:
a light source;
an optical modulator that performs optical modulation on light received from the light source by using a transmission signal and that transmits transmission light; and
an optical device that guides the light inside the optical modulator, wherein the optical device further includes
a first assembly layer that is formed on a substrate on a side closer to the substrate; and
a second assembly layer that is formed on the substrate on a side away from the substrate; wherein the optical device further includes
two first waveguides that are arranged in a side by side manner in the first assembly layer;
two second waveguides that are arranged in a side by side manner in the second assembly layer; and
a single third waveguide that is arranged between the first waveguides and between the second waveguides, wherein
each of the first waveguides includes
a first tapered waveguide, and
a second tapered waveguide that is connected to the first tapered waveguide,
the third waveguide includes
a third tapered waveguide that is disposed side by side with the second tapered waveguides, and
a fourth waveguide that is connected to the third tapered waveguide on a side away from each of the first tapered waveguides,
each of the first tapered waveguides has a structure in which a waveguide width is gradually narrower to a start point of the first tapered waveguide as the first tapered waveguide is away from a joining point with the associated second tapered waveguide,
each of the second tapered waveguides has a structure in which a waveguide width is gradually narrower as the second tapered waveguide is away from a joining point with the associated first tapered waveguide, and
the third tapered waveguide has a structure in which a waveguide width is gradually wider as the third tapered waveguide is closer to a joining point with the fourth waveguide.

15. An optical receiver comprising:
a light source;
a receiver that receives a reception signal from reception light by using light received from the light source; and
an optical device that guides the light inside the receiver, wherein the optical device further includes
a first assembly layer that is formed on a substrate on a side closer to the substrate; and
a second assembly layer that is formed on the substrate on a side away from the substrate; wherein the optical device further includes
two first waveguides that are arranged in a side by side manner in the first assembly layer;
two second waveguides that are arranged in a side by side manner in the second assembly layer; and
a single third waveguide that is arranged between the first waveguides and between the second waveguides, wherein
each of the first waveguides includes
a first tapered waveguide, and
a second tapered waveguide that is connected to the first tapered waveguide,
the third waveguide includes
a third tapered waveguide that is disposed side by side with the second tapered waveguides, and
a fourth waveguide that is connected to the third tapered waveguide on a side away from each of the first tapered waveguides,
each of the first tapered waveguides has a structure in which a waveguide width is gradually narrower to a start point of the first tapered waveguide as the first tapered waveguide is away from a joining point with the associated second tapered waveguide,
each of the second tapered waveguides has a structure in which a waveguide width is gradually narrower as the second tapered waveguide is away from a joining point with the associated first tapered waveguide, and
the third tapered waveguide has a structure in which a waveguide width is gradually wider as the third tapered waveguide is closer to a joining point with the fourth waveguide.
